(19) United States
(12) Patent Application Publication
(10) Pub. No.: US 2023/0411876 A1
(43) Pub. Date: Dec. 21, 2023

(54) Plugging Mechanism of LED Display Apparatus, and LED Display Apparatus

(71) Applicant: LEYARD OPTOELECTRONIC CO., LTD., Beijing (CN)

(72) Inventors: Linhua CAO, Beijing (CN); Zhiyong LIU, Beijing (CN)

(21) Appl. No.: 18/133,538

(22) Filed: Apr. 12, 2023

(30) Foreign Application Priority Data
May 30, 2022 (CN) 202210603420.3

(51) Int. Cl. H01R 12/71; H01R 13/627; H01R 13/04; H01R 13/10; G09F 9/302

(52) U.S. Cl. CPC H01R 12/71; H01R 13/627; G09F 9/302; H01R 13/10; H01R 13/04

(57) ABSTRACT

The present disclosure provides a plugging mechanism of an LED display apparatus, and an LED display apparatus, wherein the plugging mechanism of the LED display apparatus includes: a power socket; and a power plug, including a second seat body, and a second conductive member, a plurality of first driving members and a plurality of first reset members, each first driving member is able to be subjected to a first driving force opposite to a direction of a first reset force, and when the first driving force applied to each first driving member is less than a corresponding first reset force, the second conductive member is at a first disconnection position; and when the first driving force applied to each first driving member is greater than the corresponding first reset force, the second conductive member moves from the first disconnection position to a first conduction position.

### CROSS-REFERENCE TO RELATED APPLICATION

The present disclosure claims the priority to Chinese Patent Application No. 202210603420.3, filed to the Chinese Patent Office on May 30, 2022 and entitled “Plugging Mechanism of LED Display Apparatus, and LED Display Apparatus”, which is incorporated in its entirety herein by reference.

### TECHNICAL FIELD

The present disclosure relates to the technical field of LED display, and in particular, to a plugging mechanism of an LED display apparatus, and an LED display apparatus.

### BACKGROUND

In the technical field of LED (Light-Emitting Diode) display, an LED display apparatus includes a plurality of display units that are arranged side by side. When two adjacent display units are assembled together, a flexible power line and a flexible data line, which are independent of each other, are generally used for connection.

However, the wiring is complicated when the power line is connected. In order to solve the problem, a plugging mechanism is provided in the related art, the plugging mechanism includes a socket and a plug that is plugged into the socket, the socket and the plug are respectively installed on two side edges of two adjacent display units, and when the two adjacent display units are assembled together, the plug is able to be plugged into the socket.

However, the plug is easy to become loose, and when the two adjacent display units are assembled together, the plug is prone to deflection, and thus is difficult to be plugged into the socket.

### SUMMARY

The main objective of the present disclosure is to provide a plugging mechanism of an LED display apparatus, and an LED display apparatus, so as to solve the problem in the related art that the plug is prone to deflection, and thus is difficult to be plugged into the socket.

In order to achieve the above objective, according to one aspect of the present disclosure, a plugging mechanism of an LED display apparatus is provided, including: a power socket, including a first seat body and a first conductive member disposed on the first seat body; and a power plug, including a second seat body, and a second conductive member movably disposed on the second seat body, a plurality of first driving members and a plurality of first reset members; the plurality of first reset members and the plurality of first driving members are all movably disposed on the second seat body, the plurality of first reset members abut against the plurality of first driving members in a one-to-one correspondence manner, so that each first reset member applies a first reset force to a corresponding first driving member, and the second conductive member has a first conduction position of penetrating through the second seat body and forming contact conduction with the first conductive member, and a first disconnection position of retracting into the second seat body and separating from the first conductive member, wherein each first driving member is able to be subjected to a first driving force opposite to a direction of the first reset force, and when the first driving force applied to each first driving member is less than a corresponding first reset force, the second conductive member is at the first disconnection position; and when the first driving force applied to each first driving member is greater than the corresponding first reset force, the plurality of first driving members move to drive the second conductive member to move towards the first conductive member, so that the second conductive member moves from the first disconnection position to the first conduction position.

In some embodiments, each first driving member includes a first driving rod movably disposed on the second seat body in a penetrating manner, and a first lever plate swingably disposed in the second seat body, one side of a first end of the first lever plate abuts against the first driving rod, a second end of the first lever plate is linked with the second conductive member, each first reset member abuts against the other side of the first end of the first lever plate of the corresponding first driving member, and each first reset member is floatingly disposed in an axial direction of the first driving rod of the corresponding first driving member.

In some embodiments, the second seat body is provided with a mounting hole, the first reset member is a first reset rod movably disposed in the mounting hole in a penetrating manner, the power plug further includes a first elastic member disposed in the mounting hole, the first elastic member applies an elastic force, towards the first driving rod, to the first reset rod, a part of the first reset rod penetrating out of the mounting hole is provided with a stop adjusting member, and the stop adjusting member is in stop fit with a side surface of the second seat body facing away from the first seat body.

In some embodiments, the first lever plate includes a first plate segment, a rotating shaft and a second plate segment, which are connected in sequence, an obtuse included angle is formed between the first plate segment and the second plate segment, the rotating shaft is rotatably disposed in the second seat body, the first plate segment abuts against the first driving rod, the second plate segment is linked with the second conductive member, and an end of the first reset rod is provided with an abutting inclined plane that abuts against the first plate segment.

In some embodiments, the second seat body includes a seat body base and a bottom plate covering the seat body base, a first arc-shaped recess is disposed on the seat body base, a second arc-shaped recess is disposed on a surface of the bottom plate facing the first arc-shaped recess, and the rotating shaft is clamped between the first arc-shaped recess and the second arc-shaped recess.

In some embodiments, each first driving member further includes a first connecting rod, in each first driving member, a first end of the first connecting rod is hinged with the second end of the first lever plate, and a second end of the first connecting rod is hinged with the second conductive member.

In some embodiments, the power socket further includes a first force application member spaced apart from the first seat body, and the first force application member is movably disposed and is capable of pushing the first driving rod to move, so as to drive the first lever plate to swing; and the power socket further includes a first mounting seat spaced apart from the first seat body, and a second elastic member disposed in the first mounting seat, the first force application member is movably located in the first mounting seat, the second elastic member applies an elastic force, towards the first driving rod, to the first force application member, and the first force application member is able to be in point-surface contact fit with the first driving rod.

In some embodiments, the power plug further includes a third elastic member disposed between the second seat body and the second conductive member, and the third elastic member applies an elastic force, in a direction facing away from the first seat body, to the second conductive member; and/or, when the second conductive member is at the first conduction position, the second conductive member is in point-surface contact fit with the first conductive member.

In some embodiments, the power socket further includes a switch member, and the switch member enables the first conductive member itself to be in an on state or an off state.

In some embodiments, the first conductive member includes an input conductor and an output conductor, which are installed in the first seat body, the input conductor and the output conductor are disconnected, the switch member includes a connecting conductor installed in the first seat body, and an operation key for driving the connecting conductor to move, and when the connecting conductor moves to cooperate with the input conductor and the output conductor, the connecting conductor conducts the input conductor and the output conductor.

In some embodiments, the plugging mechanism further includes: a signal socket, including a third seat body, and a first signal transmission member disposed on the third seat body; and a signal plug, including a fourth seat body, a second signal transmission member movably disposed on the fourth seat body, and a plurality of second driving members and a plurality of second reset members; the plurality of second reset members and the plurality of second driving members are all movably disposed on the fourth seat body, the plurality of second reset members abut against the plurality of second driving members in a one-to-one correspondence manner, so that each second reset member applies a second reset force to a corresponding second driving member, the second signal transmission member has a second conduction position of penetrating through the fourth seat body and forming contact conduction with the first signal transmission member, and a second disconnection position of retracting into the fourth seat body and separating from the first signal transmission member, wherein each second driving member is able to be subjected to a second driving force opposite to a direction of the second reset force, and when the second driving force applied to each second driving member is less than a corresponding second reset force, the second signal transmission member is at the second disconnection position; and when the second driving force applied to each second driving member is greater than the corresponding second reset force, the plurality of second driving members move to drive the second signal transmission member to move towards the first signal transmission member, so that the second signal transmission member moves from the second disconnection position to the second conduction position.

In some embodiments, each second driving member includes a second driving rod movably disposed on the fourth seat body in a penetrating manner, and a second lever plate swingably disposed in the fourth seat body, one side of a first end of the second lever plate abuts against the second driving rod, a second end of the second lever plate is linked with the second signal transmission member, each second reset member abuts against the other side of the first end of the second lever plate of the corresponding second driving member, and each second reset member is floatingly disposed in an axial direction of the second driving rod of the corresponding second driving member; each second driving member further includes a second connecting rod, in each second driving member, a first end of the second connecting rod is hinged with the second end of the second lever plate, and a second end of the second connecting rod is hinged with the second signal transmission member; the signal socket further includes a second force application member spaced apart from the third seat body, and the second force application member is movably disposed and is capable of pushing the second driving rod to move, so as to drive the second lever plate to swing; the signal socket further includes a second mounting seat spaced apart from the third seat body, and a fourth elastic member disposed in the second mounting seat, the second force application member is movably located in the second mounting seat, the fourth elastic member applies an elastic force, towards the second driving rod, to the second force application member, and the second force application member is able to be in point-surface contact fit with the second driving rod; and the signal plug further includes a fifth elastic member disposed between the fourth seat body and the second signal transmission member, and the fifth elastic member applies an elastic force, in a direction facing away from the third seat body, to the second signal transmission member; and/or, when the second signal transmission member is at the second conduction position, the second signal transmission member is in point-surface contact fit with the first signal transmission member.

According to another aspect of the present disclosure, an LED display apparatus is provided, including a first display unit, a second display unit, a plugging mechanism and a plurality of LED display modules, wherein the first display unit and the second display unit are disposed side by side, the plugging mechanism is the above plugging mechanism of the LED display apparatus, the power socket of the plugging mechanism is installed on a side edge of the first display unit that is adjacent to the second display unit, and the power plug of the plugging mechanism is installed on a side edge of the second display unit that is adjacent to the first display unit.

According to another aspect of the present disclosure, an LED display apparatus is provided, including a first display unit, a second display unit, a third display unit, a fourth display unit and a plugging mechanism, wherein the first display unit, the second display unit, the third display unit and the fourth display unit are arranged in an array and are sequentially distributed in a circumferential direction, the plugging mechanism is the above plugging mechanism of the LED display apparatus, the power socket of the plugging mechanism is installed on a side edge of the first display unit that is adjacent to the second display unit, and the power plug of the plugging mechanism is installed on a side edge of the second display unit that is adjacent to the first display unit, wherein the signal socket of the plugging mechanism is installed on the side edge of the first display unit that is adjacent to the second display unit; the signal plug of the plugging mechanism is installed on the side edge of the second display unit that is adjacent to the first display unit; and/or, the signal socket of the plugging mechanism is installed on a side edge of the first display unit that is adjacent to the fourth display unit, and the signal plug of the plugging mechanism is installed on a side edge of the fourth display unit that is adjacent to the first display unit.

By applying the technical solutions of the present disclosure, the plugging mechanism of the LED display apparatus includes: the power socket and the power plug. The power socket of the plugging mechanism of the LED display apparatus is installed on an adjacent side edge of two adjacent display units, and the power plug of the plugging mechanism of the LED display apparatus is installed on the other adjacent side edge of the two adjacent display units. The power socket includes the first seat body, and the first conductive member disposed on the first seat body. The power plug includes the second seat body, and the second conductive member movably disposed on the second seat body, the plurality of first driving members and the plurality of first reset members. The plurality of first reset members and the plurality of first driving members are all movably disposed on the second seat body, and the plurality of first reset members abut against the plurality of first driving members in the one-to-one correspondence manner, so that each first reset member applies the first reset force to the corresponding first driving member, and the second conductive member has the first conduction position of penetrating through the second seat body and forming contact conduction with the first conductive member, and the first disconnection position of retracting into the second seat body and separating from the first conductive member. During a process of assembling the two adjacent display units together, each first driving member is subjected to the first driving force opposite to the direction of the first reset force, and when the first driving force applied to each first driving member is less than the corresponding first reset force, the second conductive member is at the first disconnection position, and the plurality of first driving members cannot move or retract into the second seat body, thereby preventing the second conductive member from being obliquely plugged into the first seat body. When the first driving force applied to each first driving member is greater than the corresponding first reset force, the plurality of first driving members move to drive the second conductive member to move towards the first conductive member, so that the second conductive member moves from the first disconnection position to the first conduction position. During this process, each first reset member applies the first reset force to the corresponding first driving member, the plurality of first driving members are simultaneously subjected to the first driving forces that enable the first driving members to move, and thus the plurality of first driving members simultaneously drive the second conductive member to move, the second conductive member stably penetrate through the second seat body and be plugged into the first seat body, thereby preventing the second conductive member from deflecting, so that the second conductive member smoothly moves from the first disconnection position to the first conduction position. Therefore, the technical solutions of the present application solve the problem in the related art that the plug is prone to deflection and thus is difficult to be plugged into the socket. Moreover, when the two adjacent display units are assembled together, a power line is connected by plugging the power socket and the power plug, such that the wiring operation is simplified, the connection of the power line is simple, the assembly of the two adjacent display units is simpler and more convenient, and the assembly efficiency is improved.

### BRIEF DESCRIPTION OF THE DRAWINGS

The drawings, which constitute a part of the present application, are used to provide a further understanding of the present disclosure, and illustrative embodiments of the present disclosure and descriptions thereof are used to explain the present disclosure, and do not constitute improper limitations to the present disclosure. In the drawings:

FIG. 1 illustrates a schematic side view of an embodiment of an LED display apparatus according to the present disclosure;

FIG. 2 illustrates a schematic cross-sectional view in an A1-A1 direction of the LED display apparatus of FIG. 1;

FIG. 3 illustrates a schematic partial enlarged view of B1 of the LED display apparatus of FIG. 2;

FIG. 4 illustrates a schematic cross-sectional view in an A2-A2 direction of the LED display apparatus of FIG. 1;

FIG. 5 illustrates a schematic partial enlarged view of B2 of the LED display apparatus of FIG. 4;

FIG. 6 illustrates a schematic cross-sectional view in an A3-A3 direction of the LED display apparatus of FIG. 1;

FIG. 7 illustrates a schematic partial enlarged view of B3 of the LED display apparatus of FIG. 6;

FIG. 8 illustrates a schematic cross-sectional view in an A4-A4 direction of the LED display apparatus of FIG. 1;

FIG. 9 illustrates a schematic partial enlarged view of B4 of the LED display apparatus of FIG. 8;

FIG. 10 illustrates a schematic circuit diagram of an embodiment of a plugging mechanism of an LED display apparatus according to the present disclosure;

FIG. 11 illustrates a schematic front view of a power plug of the plugging mechanism of the LED display apparatus of FIG. 10;

FIG. 12 illustrates a schematic side view of the power plug of FIG. 11;

FIG. 13 illustrates a schematic cross-sectional view in a C1-C1 direction of the power plug of FIG. 12;

FIG. 14 illustrates a schematic cross-sectional view in a C2-C2 direction of the power plug of FIG. 12;

FIG. 15 illustrates a schematic cross-sectional view in a C3-C3 direction of the power plug of FIG. 12;

FIG. 16 illustrates a schematic front view of a power socket of FIG. 10;

FIG. 17 illustrates a schematic cross-sectional view in a D1-D1 direction of the power socket of FIG. 16;

FIG. 18 illustrates a schematic side view of the power socket of FIG. 16;

FIG. 19 illustrates a schematic cross-sectional view in a D2-D2 direction of the power socket of FIG. 18;

FIG. 20 illustrates a schematic cross-sectional view in which an external power plug is plugged into an external socket of the power socket of FIG. 16;

FIG. 21 illustrates a schematic bottom view of the power socket of FIG. 16;

FIG. 22 illustrates a schematic front view of a signal plug of FIG. 10;

FIG. 23 illustrates a schematic side view of the signal plug of FIG. 22;

FIG. 24 illustrates a schematic cross-sectional view in an E1-E1 direction of the signal plug of FIG. 23;

FIG. 25 illustrates a schematic cross-sectional view in an E2-E3 direction of the signal plug of FIG. 23;

FIG. 26 illustrates a schematic cross-sectional view in an E3-E3 direction of the signal plug of FIG. 23;

FIG. 27 illustrates a schematic top view of the signal plug of FIG. 22;

FIG. 28 illustrates a schematic front view of a signal socket of FIG. 10; and

FIG. 29 illustrates a schematic top view of the signal socket of FIG. 28.

The above drawings include the following reference signs:
10. power socket; 11. first seat body; 12. first conductive member; 121. input conductor; 122. output conductor; 13. first force application member; 14. first mounting seat; 15. second elastic member; 16. switch member; 161. operation key; 20. power plug; 21. second seat body; 211. seat body base; 212. bottom plate; 213. first arc-shaped recess; 214. second arc-shaped recess; 22. second conductive member; 23. first driving member; 231. first driving rod; 232. first lever plate; 2321. first plate segment; 2322, rotating shaft; 2323. second plate segment; 233. first connecting rod; 24. first reset member; 241. first reset rod; 25. first elastic member; 26. stop adjusting member; 27. third elastic member; 30. signal socket; 31. third seat body; 32. first signal transmission member; 33. second force application member; 34. second mounting seat; 35. fourth elastic member; 40. signal plug; 41. fourth seat body; 42. second signal transmission member; 43. second driving member; 431. second driving rod; 432. second lever plate; 433. second connecting rod; 432. second reset member; 45. fifth elastic member; 51. first display unit; 52. second display unit; 53. third display unit; 54. fourth display unit; 62. external power plug.

### DETAILED DESCRIPTION OF THE EMBODIMENTS

A clear and complete description of technical solutions in the embodiment of the present disclosure will be given below, in combination with the drawings in the embodiment of the present disclosure. Apparently, the embodiments described below are merely a part, but not all, of the embodiments of the present disclosure. The following description of at least one exemplary embodiment is merely illustrative in nature and is in no way intended as any limitation to the present disclosure and its application or use. All of other embodiments, obtained by those ordinary skilled in the art based on the embodiments in the present disclosure without any creative effort, fall into the protection scope of the present disclosure.

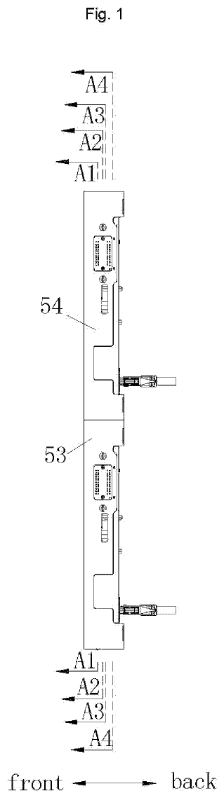

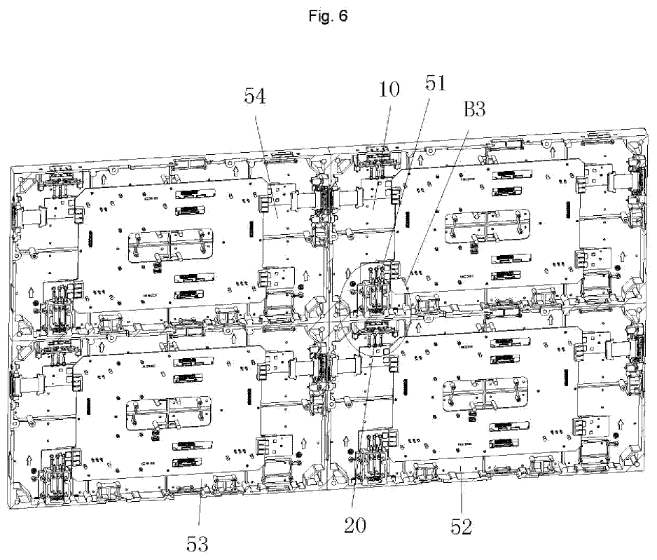

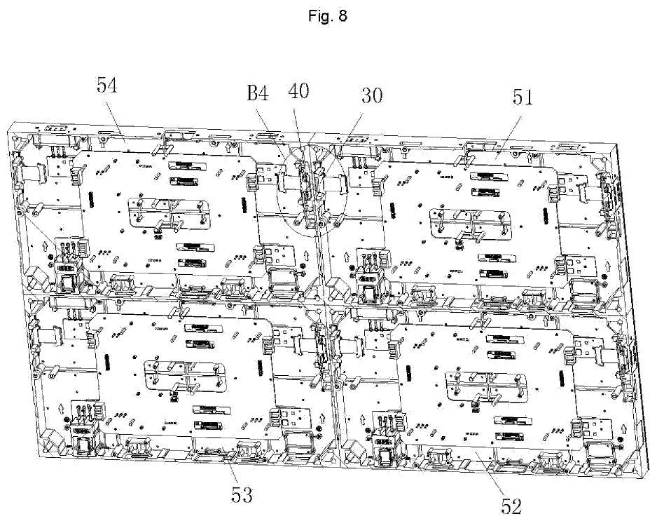

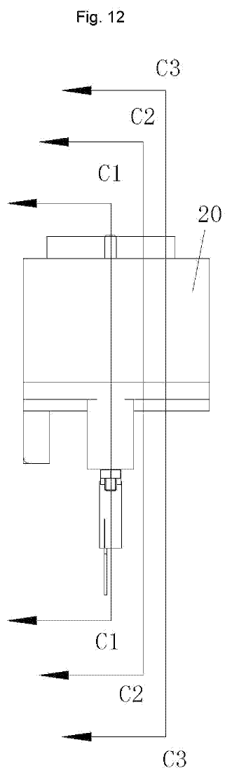

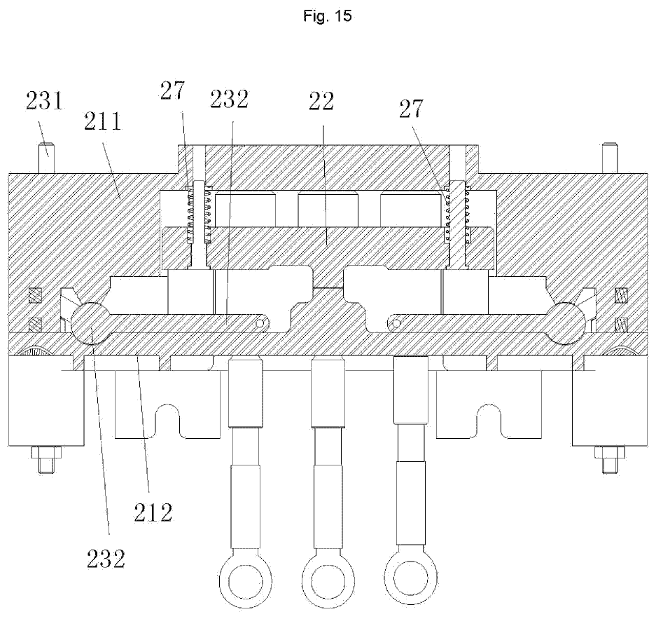

As shown in FIG. 1 to FIG. 16, a plugging mechanism of an LED display apparatus of the present embodiment includes: a power socket 10 and a power plug 20. The power socket 10 includes a first seat body 11, and a first conductive member 12 disposed on the first seat body 11. The power plug 20 includes a second seat body 21, and a second conductive member 22 movably disposed on the second seat body 21, two first driving members 23 and two first reset members 24. The two first reset members 24 and the two first driving members 23 are all movably disposed on the second seat body 21. The two first reset members 24 abut against the two first driving members 23 in a one-to-one correspondence manner, so that each first reset member 24 applies a first reset force to a corresponding first driving member 23, and the second conductive member 22 has a first conduction position of penetrating through the second seat body 21 and forming contact conduction with the first conductive member 12, and a first disconnection position of retracting into the second seat body 21 and separating from the first conductive member 12. In the present embodiment, each first driving member 23 is able to be subjected to a first driving force opposite to a direction of the first reset force, and when the first driving force applied to each first driving member 23 is less than a corresponding first reset force, the second conductive member 22 is at the first disconnection position; and when the first driving force applied to each first driving member 23 is greater than the corresponding first reset force, the two first driving members 23 move to drive the second conductive member 22 to move towards the first conductive member 12, so that the second conductive member 22 moves from the first disconnection position to the first conduction position.

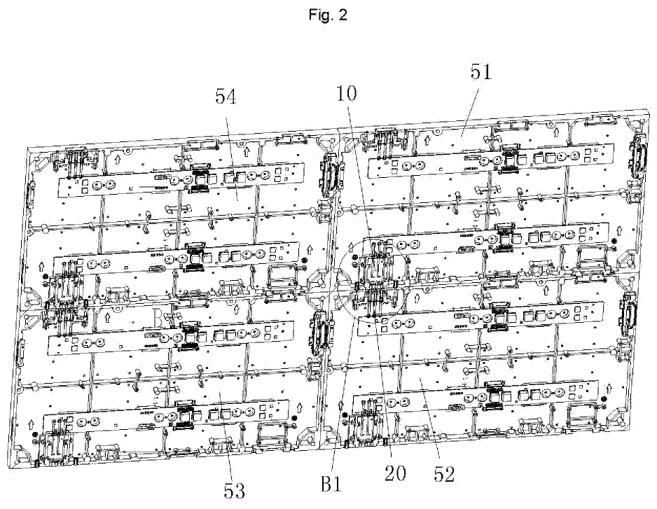

By applying the technical solutions of the present embodiment, the power socket 10 of the plugging mechanism of the LED display apparatus is installed on an adjacent side edge of two adjacent display units, and the power plug 20 of the plugging mechanism of the LED display apparatus is installed on the other adjacent side edge of the two adjacent display units. During a process of assembling the two adjacent display units, each first driving member 23 is subjected to the first driving force opposite to the direction of the first reset force, and when the first driving force applied to each first driving member 23 is less than the corresponding first reset force, the second conductive member 22 is at the first disconnection position, and the two first driving members 23 cannot move or retract into the second seat body 21, thereby preventing the second conductive member 22 from being obliquely plugged into the first seat body 11. When the first driving force applied to each first driving member 23 is greater than the corresponding first reset force, the two first driving members 23 move to drive the second conductive member 22 to move towards the first conductive member 12, so that the second conductive member 22 moves from the first disconnection position to the first conduction position. During this process, each first reset member 24 applies the first reset force to the corresponding first driving member 23, the two first driving members 23 are simultaneously subjected to the first driving forces that enable the two first driving members 23 to move, and thus the two first driving members 23 simultaneously drive the second conductive member 22 to move, the second conductive member 22 stably penetrates through the second seat body 21 and be plugged into the first seat body 11, thereby preventing the second conductive member 22 from deflecting, so that the second conductive member 22 smoothly moves from the first disconnection position to the first conduction position. Therefore, the technical solutions of the present embodiment solve the problem in the related art that the plug is prone to deflection and thus is difficult to be plugged into the socket. Moreover, when the two adjacent display units are assembled together, a power line is connected by plugging the power socket 10 and the power plug 20, such that the wiring operation is simplified, the assembly of the two adjacent display units is simpler and more convenient, and the assembly efficiency is improved. The two adjacent display units mentioned above may be a first display unit 51 and a second display unit 52 in FIG. 2.

It should be noted that, when the first driving force applied to each first driving member 23 is less than the corresponding first reset force, the second conductive member 22 is at the first disconnection position, and at this time, the second conductive member 22 switches from the first conduction position to the first disconnection position. Or, when each first driving member 23 is not subjected to the first driving force, the second conductive member 22 remains at the first disconnection position.

In embodiments not shown in the figures, the number of the first driving members and the number of the first reset members may not be limited to two, and may also be three or more.

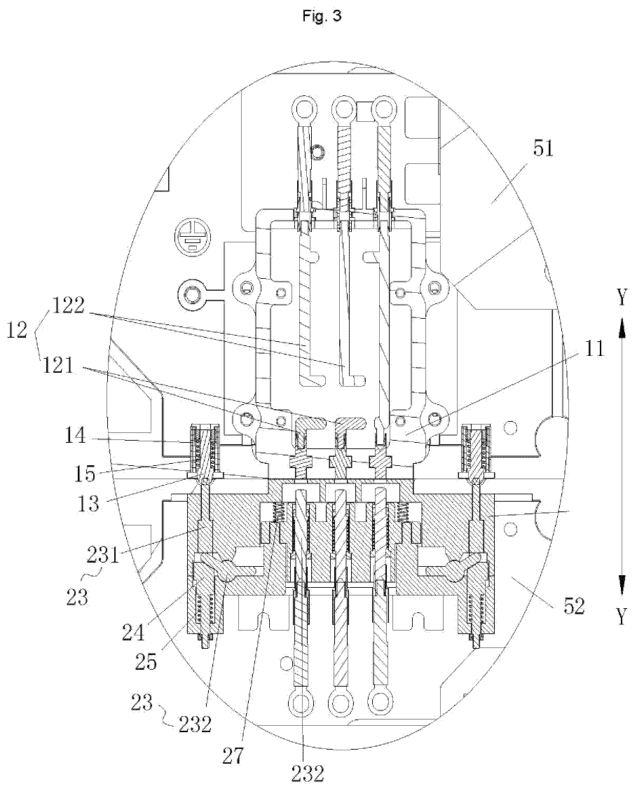

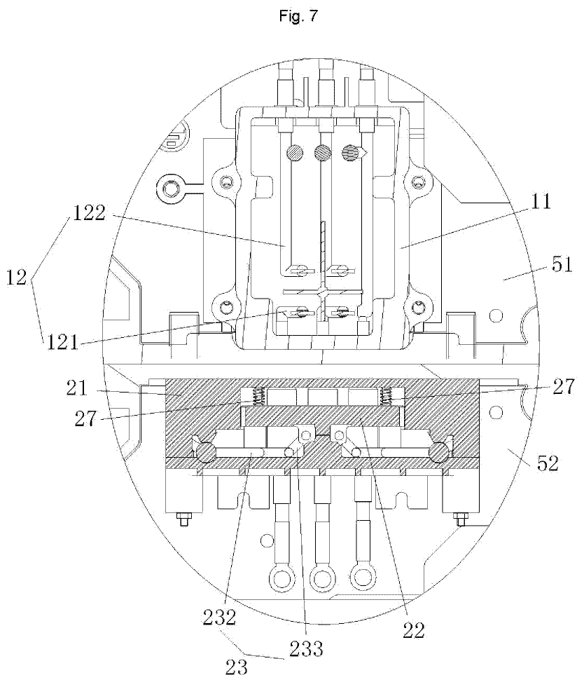

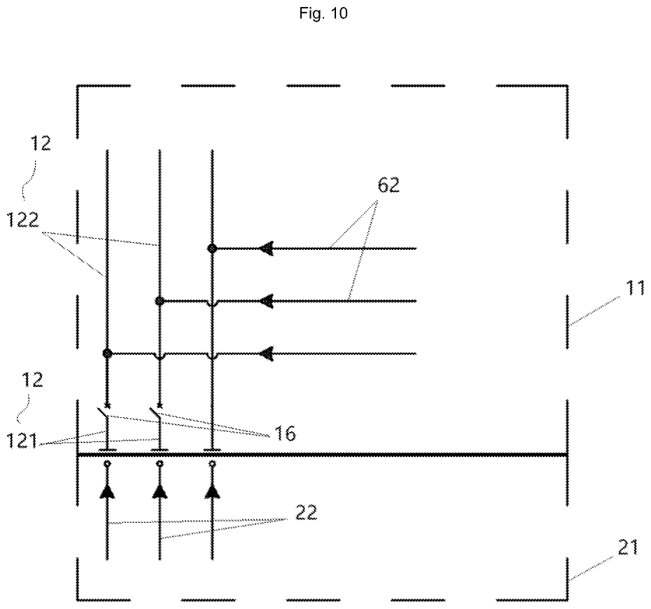

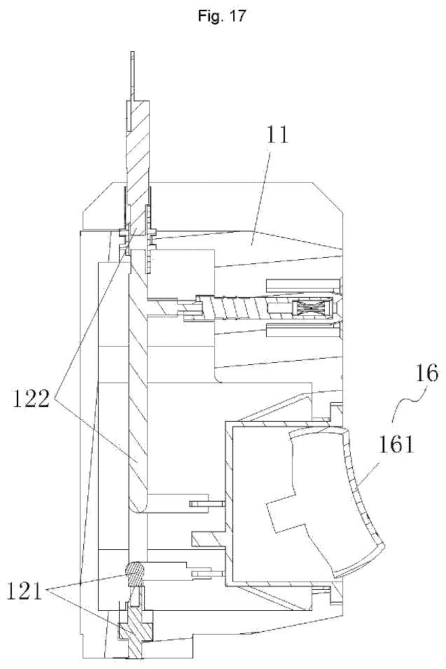

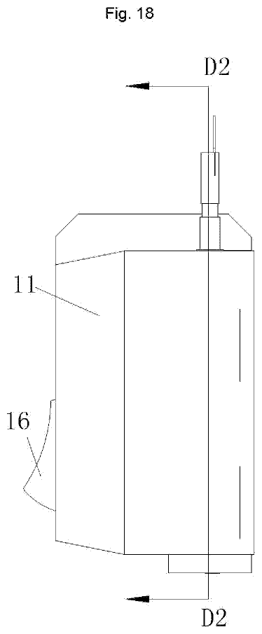

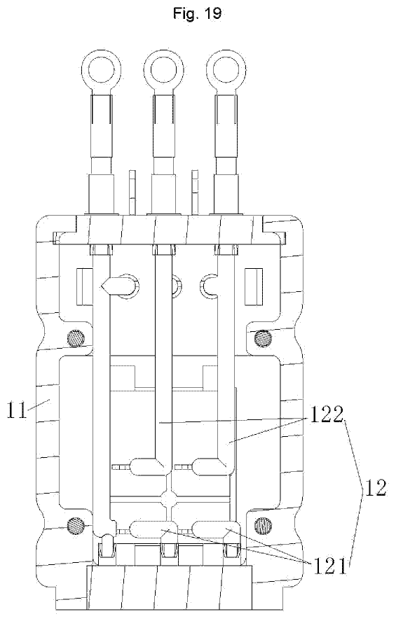

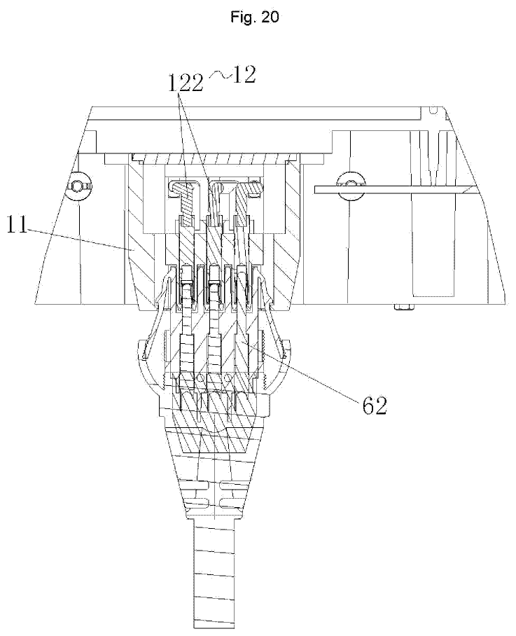

As shown in FIG. 3, FIG. 7, and FIG. 10 to FIG. 20, each first driving member 23 includes a first driving rod 231 movably disposed on the second seat body 21 in a penetrating manner, and a first lever plate 232 swingably disposed in the second seat body 231. One side of a first end of the first lever plate 232 abuts against the first driving rod 231, a second end of the first lever plate 232 is linked with the second conductive member 22, each first reset member 24 abuts against the other side of the first end of the first lever plate 232 of the corresponding first driving member 23, and each first reset member 24 is floatingly disposed in an axial direction of the first driving rod 231 of the corresponding first driving member 23.

In the present embodiment, the driving cooperation between the first driving rod 231 and the first lever plate 232 is similar to the lever principle, so that the first driving member 23 drives the second conductive member 22 to move, which is more labor-saving. In order to enable the second conductive member 22 to move more smoothly, the other sides of the first ends of the two first lever plates 232 abut against the two first reset members 24 in a one-to-one correspondence manner, and the two first lever plates 232 are respectively located on two sides of the second conductive member 22.

As shown in FIG. 3, FIG. 7, and FIG. 10 to FIG. 20, the second seat body 21 is provided with a mounting hole, and the first reset member 24 is a first reset rod 241 movably disposed in the mounting hole in a penetrating manner. The power plug 20 further includes a first elastic member 25 disposed in the mounting hole. The first elastic member 25 applies an elastic force, towards the first driving rod 231, to the first reset rod 241. Under the action of the elastic force of the first elastic member 25, the first end of the first lever plate 232 is always in an abutting state with an end of the first driving rod 231, and when the first driving force applied to each first driving member 23 is greater than the corresponding first reset force, the first driving rod 231 moves downwards and pushes the first end of the first lever plate 232 to swing, so that the first end of the first lever plate 232 pushes the first reset rod 241 to move in the second seat body 21. When the first driving force applied to each first driving member 23 is less than the corresponding first reset force, the first end of the first lever plate 232 is always in the abutting state with the end of the first driving rod 231, the first end of the first lever plate 232 does not swing, and the second conductive member 22 is located at the first disconnection position, thereby avoiding a misoperation, or preventing the second conductive member 22 from penetrating through the second seat body 21 due to uneven first driving forces.

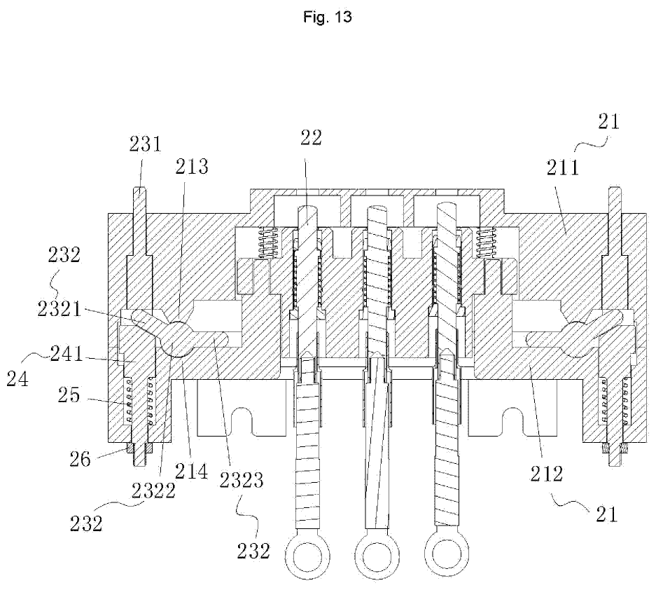

As shown in FIG. 13, in the present embodiment, during the process of mounting the first lever plate 232 in the second seat body 21, since the first elastic member 25 applies the elastic force, towards the first driving rod 231, to the first reset rod 241, and the space between the first driving rod 231 and the first reset rod 241 is relatively small, the first end of the first lever plate 232 is inconvenient to be placed between the first driving rod 231 and the first reset rod 241. In order to easily place the first end of the first lever plate 232, a part of the first reset rod 241 penetrating out of the mounting hole is provided with a stop adjusting member 26, and the stop adjusting member 26 is in stop fit with a side surface of the second seat body 21 facing away from the first seat body 11. By using of the stop adjusting member 26, the first reset rod 241 is stopped at an avoidance position of avoiding the first end of the first lever plate 232, at this time, a sufficient space is reserved between the first driving rod 231 and the first reset rod 241, so that the first end of the first lever plate 232 is conveniently placed in the space, and then adjusting the position of the stop adjusting member 26 on the first reset rod 241, so that the first reset rod 241 always applies the first reset force to the other side of the first end of the first lever plate 232. Preferably, the part of the first reset rod 241 penetrating out of the mounting hole is provided with threads, the stop adjusting member 26 is a nut, and the nut is rotatably sleeved on the threads.

As shown in FIG. 3 and FIG. 13, the first lever plate 232 includes a first plate segment 2321, a rotating shaft 2322 and a second plate segment 2323, which are connected in sequence. An obtuse included angle is formed between the first plate segment 2321 and the second plate segment 2323, the rotating shaft 2322 is rotatably disposed in the second seat body 21, the first plate segment 2321 abuts against the first driving rod 231, and the second plate segment 2323 is linked with the second conductive member 22.

As shown in FIG. 13, an end of the first reset rod 241 is provided with an abutting inclined plane that abuts against the first plate segment 2321. In this way, the abutting inclined plane of the first reset rod 241 is matched with an inclination direction of the first plate segment 2321, therefore on one hand, the first reset rod 241 can conveniently avoid the first plate segment 2321 at the end towards the first plate segment 2321, and on the other hand, the abutting inclined plane is in surface-surface contact with the plate surface of the first plate segment 2321, thereby improving the stability of the swing of the first plate segment 2321 around the rotating shaft 2322.

In the present embodiment, in order to facilitate the assembly, a positioning protrusion is disposed on a side wall of the first reset rod 241, and a positioning groove cooperating with the positioning protrusion is formed in the second seat body 21.

As shown in FIG. 3 and FIG. 13, the second seat body 21 includes a seat body base 211 and a bottom plate 212 covering the seat body base 211, a first arc-shaped recess 213 is disposed on the seat body base 211, a second arc-shaped recess 214 is disposed on a surface of the bottom plate 212 facing the first arc-shaped recess 213, and the rotating shaft 2322 is clamped between the first arc-shaped recess 213 and the second arc-shaped recess 214. In this way, both the first arc-shaped recess 213 and the second arc-shaped recess 214 are in surface-surface fit with a side surface of the rotating shaft 2322, so as to prevent the first lever plate 232 from shaking in the process of swinging around the axis of the rotating shaft, so that the first lever plate 232 swings more stably, and the swinging sensitivity can be improved, and thus the first lever plate 232 can easily drive the second conductive member 22 to move.

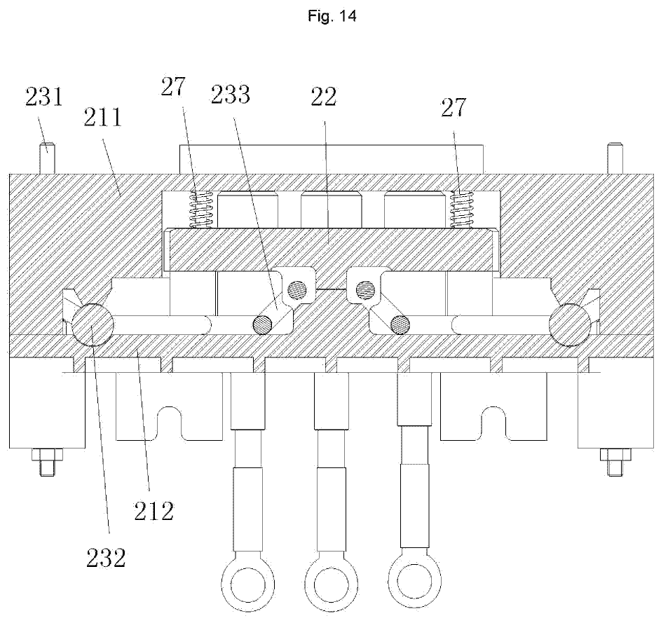

As shown in FIG. 3, FIG. 7, FIG. 13 and FIG. 14, each first driving member 23 further includes a first connecting rod 233, in each first driving member 23, a first end of the first connecting rod 233 is hinged with the second end of the first lever plate 232, and a second end of the first connecting rod 233 is hinged with the second conductive member 22. In this way, the second plate segment 2323 is linked with the second conductive member 22 by the first connecting rod 233. When the first driving force applied to each first driving member 23 is greater than the corresponding first reset force, the first driving rod 231 moves downwards and pushes the first plate segment 2321 to swing around the rotating shaft 2322, then the second plate segment 2323 swings around the rotating shaft 2322 and pushes the first connecting rod 233 to push the second conductive member 22 to move upwards, and the second conductive member 22 can stably move from the first disconnection position to the first conduction position. In this way, by making the first lever plate 232 linked with the first connecting rod 233, the stability and reliability of each first driving member 23 for driving the second conductive member 22 to move is improved.

Specifically, an insulating substrate of the second conductive member 22 includes a substrate block, and a first protrusion and a second protrusion, which are disposed on a lower surface of the substrate block at an interval. Two first lever plates 232 are provided, the second end of one first lever plate 232 is hinged with the first protrusion by one first connecting rod 233, and the second end of the other first lever plate 232 is hinged with the second protrusion by another first connecting rod 233.

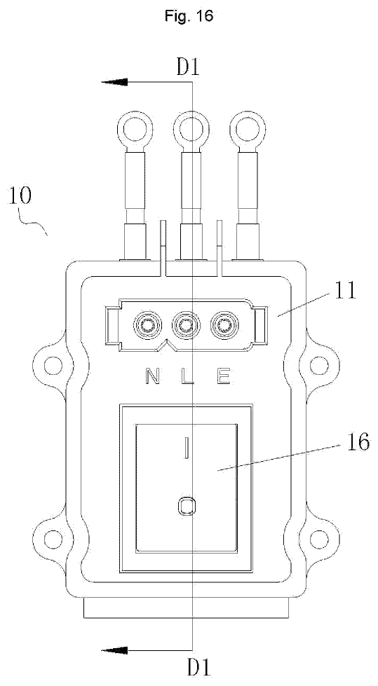

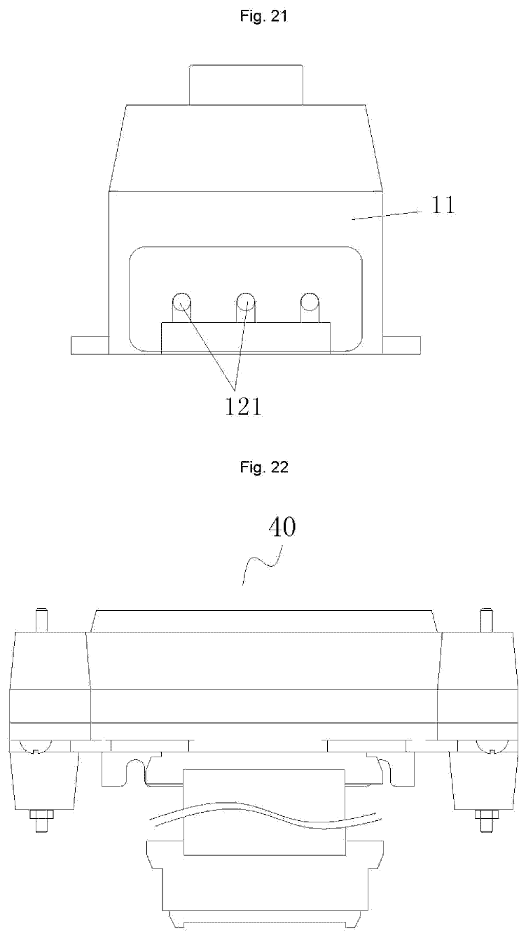

As shown in FIG. 3, FIG. 7, and FIG. 16 to FIG. 21, the power socket 10 further includes a switch member 16, and the switch member 16 enables the first conductive member 12 itself to be in an on state or an off state. When the first conductive member 12 is conducted with an external power supply, and when the assembly of the display units is continued, the first conductive member 12 may be in the off state by using the switch member 16, so that the assembled display unit is not powered on, thereby reducing the possibility of occurrence of a safety accident, and solving the problem in the related art that the power line is conducted with the external power supply, so the safety accident is likely to occur when the assembly of the display units is continued. The above switch member 16 is preferably a rocker switch.

In order to enable an external power plug 62 to be conveniently plugged into the power socket 10, the power socket 10 further includes an external socket electrically connected with the first conductive member 12, and the external socket is located in the first seat body 11. In this way, the external power plug 62 can be plugged into the external socket to realize contact conduction, and accordingly, the first conductive member 12 can be conducted with an external power supply.

Specifically, the external power plug 62 includes an external power line copper needle, and the power socket 10 further includes a power crown spring, which is in contact fit with the external power line copper needle.

As shown in FIG. 3, FIG. 7, and FIG. 16 to FIG. 21, the first conductive member 12 includes an input conductor 121 and an output conductor 122, which are installed in the first seat body 11, the input conductor 121 and the output conductor 122 are disconnected, the switch member 16 includes a connecting conductor installed in the first seat body 11, and an operation key 161 for driving the connecting conductor to move, and when the connecting conductor moves to cooperate with the input conductor 121 and the output conductor 122, the connecting conductor conducts the input conductor 121 and the output conductor 122. When the connecting conductor moves to respectively separate from the input conductor 121 and the output conductor 122, the input conductor 121 and the output conductor 122 are disconnected from each other, so that the first conductive member 12 itself is in the off state. Moreover, since the input conductor 121 and the output conductor 122 are directly installed on the first seat body 11, the components of the power socket 10 are relatively small, and the overall structural is simple, such that the production cost is reduced, subsequent maintenance is facilitated, and it is suitable for small-batch production.

In the present embodiment, the second conductive member 22 includes the insulating substrate movably disposed on the second seat body 21, and a conductive column disposed in the insulating substrate. The conductive column is floatingly disposed relative to the insulating substrate in a moving direction of the insulating substrate. The first driving member 23 moves to drive the insulating substrate to move towards the first conductive member 12, so that the conductive column is in contact conduction with the input conductor 121. The first driving member 23 moves to drive the insulating substrate to move away from the first conductive member 12, so that the conductive column is separated from the input conductor 121.

In the present embodiment, the second seat body 21 is provided with a first avoidance hole for avoiding the conductive column, the second seat body 21 is internally provided with a first accommodating hole for mounting the third elastic member 27, and the first accommodating hole communicates with the first avoidance hole.

Specifically, mounting and gap orientation are performed in the insulating substrate, and elastic force limiting is performed by a column spring in the insulating substrate. The conductive column is placed in the insulating substrate, then the column spring is placed, then the insulating substrate is sewn in a riveting and crimping manner, and the conductive column completely floats in the insulating substrate.

Specifically, the conductive column includes a neutral wire column and a live wire column, the power plug 20 further includes a grounding column, the live wire column and the grounding column are both parallel to the neutral wire column, and the neutral wire column, the live wire column and the grounding column are all disposed on the insulating substrate at intervals in a penetrating manner. The insulating substrate isolates the neutral wire column, the live wire column and the grounding column, thereby avoiding a short circuit. The input conductor 121 includes a first neutral wire conductor and a first live wire conductor, the output conductor 122 includes a second neutral wire conductor and a second live wire conductor, the power socket 10 further includes a grounding conductor spaced apart from the second neutral wire conductor, the first driver 23 moves to drive the insulating substrate to move towards the first conductive member 12, so that the neutral wire column is in contact conduction with the first neutral wire conductor, the live wire column is in contact conduction with the first live wire conductor, and the grounding column is in contact conduction with the grounding conductor.

It should be noted that, the second conductive member 22 further includes a flexible neutral wire, a flexible live wire and a flexible ground wire, which are electrically connected with the neutral wire column, the live wire column and the grounding column, respectively, all the flexible neutral wire, the flexible live wire and the flexible ground wire are telescopically deformed, so that the conductive column can move back and forth along with the insulating substrate, and accordingly, the second conductive member 22 can be switched between the first conduction position and the first disconnection position.

Further, the first neutral wire conductor includes a neutral wire copper needle disposed in the first seat body 11 in a penetrating manner, and a neutral wire conductor segment electrically connected with the neutral wire copper needle, wherein the neutral wire copper needle is connected with the neutral wire conductor segment by welding. Likewise, the first live wire conductor includes a live wire copper needle and a live wire conductor segment, and the grounding conductor includes a grounding copper needle and a grounding conductor segment. When the second conductive member 22 is at the first conduction position, the neutral wire column of the second conductive member 22 is in point-surface contact fit with the neutral wire copper needle of the first conductive member 12, the live wire column of the second conductive member 22 is in point-surface contact fit with the live wire copper needle of the first conducive member 12, and the grounding column of the second conductive member 22 is in point-surface contact fit with the grounding copper needle of the first conductive member 12.

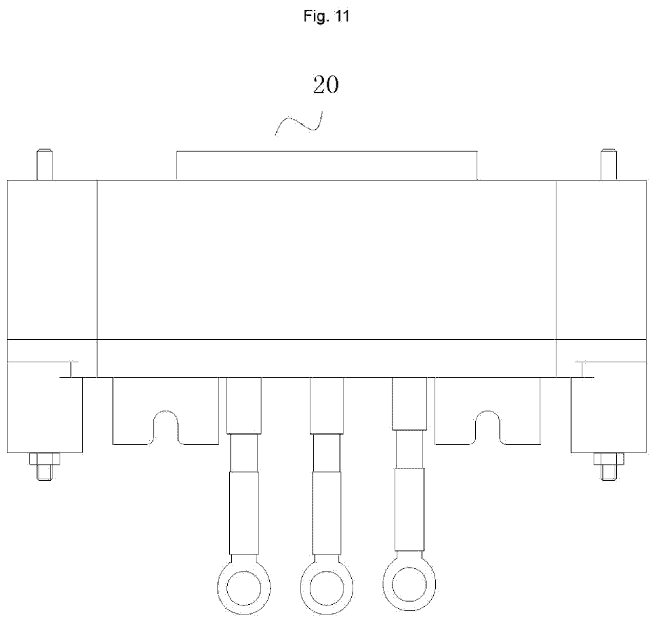

As shown in FIG. 11 to FIG. 15, in order to prevent the deflection of the insulating substrate during the process of moving in the second seat body 21, the power plug 20 further includes a guide structure disposed between the second seat body 21 and the insulating substrate. The guide structure includes a guide hole extending in the moving direction of the insulating substrate, and a guide column capable of being inserted into the guide hole, the guide hole is disposed on the second seat body 21, and the guide column is disposed on the insulating substrate. In this way, the guide column is fixedly connected with the insulating substrate, and during the moving process of the insulating substrate in the second seat body 21, since the guide column can move in the guide hole along the axis of the guide hole, it is limited that the insulating substrate can only move along the axis of the guide hole, so that the insulating substrate can stably move in the second seat body 21.

Of course, in embodiments not shown in the figures, the guide column is disposed on the second seat body, and the guide hole is disposed on the insulating substrate.

As shown in FIG. 3, FIG. 7, and FIG. 16 to FIG. 21, the power socket 10 further includes a first force application member 13 spaced apart from the first seat body 11, and the first force application member 13 is movably disposed and is capable of pushing the first driving rod 231 to move, so as to drive the first lever plate 232 to swing. The power socket 10 further includes a first mounting seat 14 spaced apart from the first seat body 11, and a second elastic member 15 disposed in the first mounting seat 14, the first force application member 13 is movably located in the first mounting seat 14, and the second elastic member 15 applies an elastic force, towards the first driving rod 231, to the first force application member 13. In this way, under the action of the elastic force of the second elastic member 15, the first force application member 13 can float in the first mounting seat 14 along a Y-axis direction of FIG. 3, during process that the second conductive member 22 moves from the first disconnection position to the first conduction position, the second elastic member 15 applies the elastic force, towards the first driving rod 231, to the first force application member 13, so that the first force application member 13 always presses the first driving rod 231, as a result, the first driving rod 231 is clamped between the first lever plate 232 and the first force application member 13, and after the first force application member 13 pushes the first driving rod 231 and the first driving force is greater than the corresponding first reset force, the first driving rod 231 quickly pushes the first end of the first lever plate 232 to swing around the rotating shaft thereof. Moreover, after two adjacent display units are disassembled, the first force application member 13 can retract into the first mounting seat 14 when subjected to collision, so as to prevent the first force application member 13 from penetrating through the first mounting seat 14 to generate interference.

As shown in FIG. 3, and FIG. 13 to FIG. 15, the power plug 20 further includes a third elastic member 27 disposed between the second seat body 21 and the second conductive member 22, and the third elastic member 27 applies an elastic force, in a direction facing away from the first seat body 11, to the second conductive member 22. In this way, under the action of the elastic force of the third elastic member 27, the second conductive member 22 can float in the second seat body 21 along the Y-axis direction of FIG. 3, and during the process that the second conductive member 22 moves from the first conduction position to the first disconnection position, the third elastic member 27 applies the elastic force, in the direction facing away from the first seat body 11, to the second conductive member 22, so that the second conductive member 22 is quickly separated from the first conductive member 12. Moreover, after the two adjacent display units are disassembled, the second conductive member 22 can be maintained at the first disconnection position, thereby avoiding the second conductive member 22 penetrating through the second seat body 21 to be damaged or generate interference. The third elastic member 27 is a spring or an elastomer, when the third elastic member 27 is a spring, the spring is preferably a pressure spring, at this time, the pressure spring is installed above the insulating substrate, of course, in embodiments not shown in the figures, the spring is preferably a tension spring, and at this time, the tension spring is installed below the insulating substrate.

As shown in FIG. 3, and FIG. 13 to FIG. 15, when the second conductive member 22 is at the first conduction position, the second conductive member 22 is in point-surface contact fit with the first conductive member 12.

It should be noted that, the point-surface contact fit between the second conductive member 22 and the first conductive member 12 refers to that the end of the conductive column of the second conductive member 22 facing the input conductor 121 is provided with a first spherical surface, the end of the input conductor 121 facing the conductive column is provided with a first plane or a first concave cambered surface, and the contact manner between the first spherical surface and the first plane or the first concave cambered surface is point-surface contact. During the process of assembling the two adjacent display units together, the conductive column with the first spherical surface smoothly penetrates through the second seat body 21 to form point-surface contact fit with the input conductor 121 with the first plane, so that the second conductive member 22 is at the first conduction position. During the process of disassembling the two adjacent display units, the conductive column with the first spherical surface smoothly retracts into the second seat body 21 to be separated from the input conductor 121 with the first plane, so that the second conductive member 22 is at the first disconnection position.

Specifically, the second seat body 21 is provided with a first avoidance hole for avoiding the conducive column, during the process that the two adjacent display units are assembled together and the second conductive member 22 moves from the first disconnection position to the first conduction position, after a part of the first spherical surface of the conductive column is in slide contact with the hole wall of the first avoidance hole, the moving direction of the conductive column is quickly adjusted, so that the axis of the conductive column is parallel to the axis of the first avoidance hole, and the conductive column can smoothly penetrate through the second seat body 21 through the first avoidance hole, so as to form point-surface contact fit with the input conductor 121.

Of course, in embodiments not shown in the figures, the power plug further includes a third elastic member disposed between the second seat body and the second conductive member, and the third elastic member applies an elastic force, in a direction facing away from the first seat body, to the second conductive member. Or, when the second conductive member is at the first conduction position, the second conductive member is in point-surface contact fit with the first conductive member.

As shown in FIG. 3, and FIG. 13 to FIG. 15, the first force application member 13 is able to be in point-surface contact fit with the first driving rod 231. It should be noted that, the point-surface contact fit between the first force application member 13 and the first driving rod 231 refers to that the end of the first force application member 13 facing the first driving rod 231 is provided with a second spherical surface, the end of the first driving rod 231 facing the first force application member 13 is provided with a second plane or a second concave cambered surface, and the contact manner between the second spherical surface and the second plane or the second concave cambered surface is point-surface contact. The second spherical surface protrudes from the surface of the first seat body 11 facing the second seat body 21, the second seat body 21 is further provided with a second avoidance hole for avoiding the first driving rod 231, the surface of the side edge of the display unit facing the first seat body 11 is provided with a first avoidance concave cambered surface for avoiding the second spherical surface, the second avoidance hole is located in the first avoidance concave cambered surface, when the second conductive member 22 is at the first disconnection position, the end of the first driving rod 231 with the second plane extends into the first avoidance concave cambered surface, and the second plane is lower than or flush with the surface of the side edge of the display unit facing the first seat body 11.

The second elastic member 15 is a spring or an elastomer. The first force application member 13 is preferably a first force application rod. The power socket 10 further includes a first stop ring disposed at the opening of the first mounting seat 14, the side wall of the first force application rod is provided with a second stop ring that is in stop fit with the first stop ring, and the second spherical surface penetrates through the first mounting seat 14 through a center hole of the first stop ring. Gap orientation is performed by the first mounting seat 14 and the second stop ring, elastic force limiting is synchronously performed by the second elastic member 15, and elastic force pressing of the second elastic member 15 and tail gap orientation of the first force application rod are guaranteed by the second stop ring, such that the first force application rod completely floats in the first mounting seat 14.

During the process that the two adjacent display units are assembled together and the second conductive member 22 moves from the first disconnection position to the first conduction position, the second spherical surface of the first force application member 13 directly forms point-surface contact fit with the second plane of the first driving rod 231, or, the second spherical surface of the first force application member 13 moves on the side edge of the display unit towards the surface of the first seat body 11, and smoothly slides into the first avoidance concave cambered surface to form point-surface contact fit with the second plane of the first driving rod 231, so that the first driving rod 231 moves downwards relative to the first seat body 11 and presses the first end of the first lever plate 232, such that the first end of the first lever plate 232 swings around the rotating shaft thereof, and the second end of the first lever plate 232 pushes the second conductive member 22 to move upwards relative to the second seat body 21, such that the second conductive member 22 is at the first conduction position.

During the process that the two adjacent display units are disassembled and the second conductive member 22 moves from the first conduction position to the first disconnection position, a part of the second spherical surface of the first force application member 13 slides on the first avoidance concave cambered surface and is gradually separated from the second plane of the first driving rod 231, and the second spherical surface of the first force application member 13 may quickly retract into the first mounting seat 14 when subjected to collision, so as to avoid interference with the second seat body 21 or the side edge of the display unit, thereby improving the smoothness of the disassembly process. After the first end of the first lever plate 232 is pushed upwards, the end of the first driving rod 231 with the second plane extends into the first avoidance concave cambered surface again. Meanwhile, the conductive column with the first spherical surface smoothly retracts into the second seat body 21 to be separated from the input conductor 121 with the first plane, so that the second conductive member 22 is at the first disconnection position.

During the process that the two adjacent display units are assembled together, the second conductive member 22 is able to float in the second seat body 21 along the Y-axis direction of FIG. 3, and the second conductive member 22 is able to smoothly perform the point-surface contact fit with the first conductive member 12; and the first force application member 13 is able to float in the first mounting seat 14 along the Y-axis direction of FIG. 3, and the first force application member 13 is able to smoothly perform the point-surface contact fit with the first driving rod 231, and there is no interference between the power plug 20 and the power socket 10, so that the power plug 20 can be quickly plugged into the power socket 10. Similarly, during the process that the two adjacent display units are disassembled, the power plug 20 can be quickly separated from the power socket 10. In this way, the power plug 20 and the power socket 10 can be automatically connected, so that the power supplies on the two display units can be automatically and electrically connected without the need for a field staff to manually plug and unplug the power plug 20, and thus the field staff can conveniently assemble or disassemble the two display units along the Y-axis direction of FIG. 3.

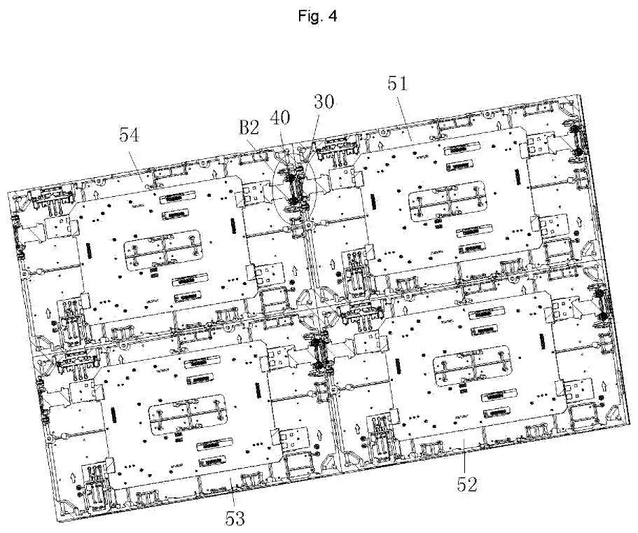

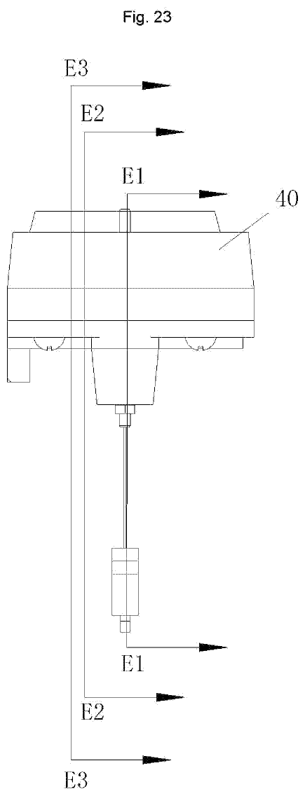

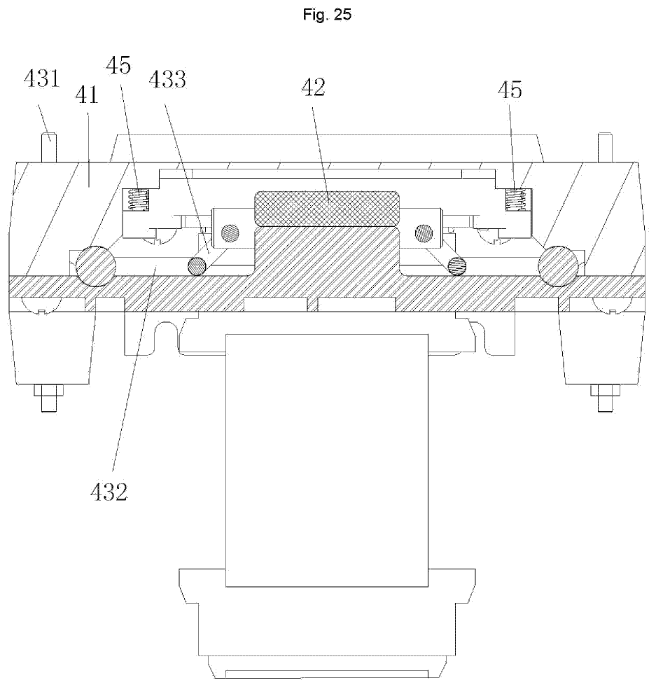

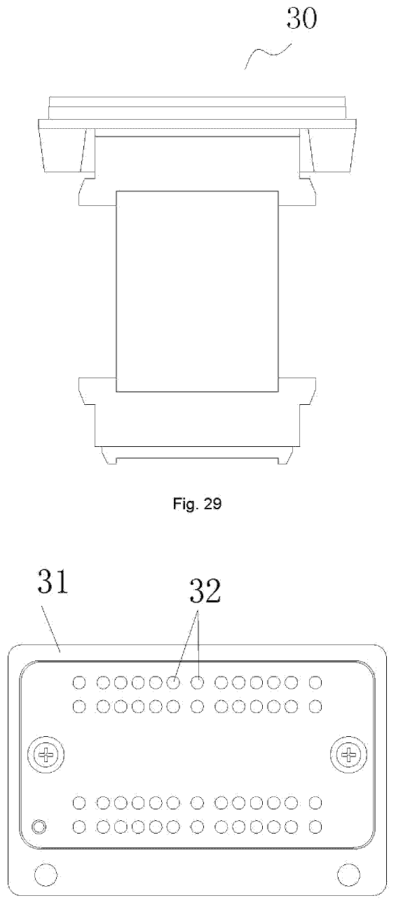

As shown in FIG. 1, FIG. 4 to FIG. 10, and FIG. 22 to FIG. 29, the plugging mechanism further includes: a signal socket 30 and a signal plug 40, and the signal socket 30 includes a third seat body 31, and a first signal transmission member 32 disposed on the third seat body 31. The signal plug 40 includes a fourth seat body 41, a second signal transmission member 42 movably disposed on the fourth seat body 41, and two second driving members 43 and two second reset members 44. The two second reset members 44 and the two second driving members 43 are all movably disposed on the fourth seat body 41, two second reset members 44 abut against the two second driving members 43 in a one-to-one correspondence manner, so that each second reset member 44 applies a second reset force to a corresponding second driving member 43, and the second signal transmission member 42 has a second conduction position of penetrating through the fourth seat body 44 and forming contact conduction with the first signal transmission member 32, and a second disconnection position of retracting into the fourth seat body 41 and separating from the first signal transmission member 32. In the present embodiment, each second driving member 43 is able to be subjected to a second driving force opposite to a direction of the second reset force, and when the second driving force applied to each second driving member 43 is less than a corresponding second reset force, the second signal transmission member 42 is at the second disconnection position. When the second driving force applied to each second driving member 43 is greater than the corresponding second reset force, the two second driving members 43 move to drive the second signal transmission member 42 to move towards the first signal transmission member 32, so that the second signal transmission member 42 moves from the second disconnection position to the second conduction position.

In the present embodiment, the signal socket 30 of the plugging mechanism of the LED display apparatus is installed on an adjacent side edge of the two adjacent display units, the signal plug 40 of the plugging mechanism of the LED display apparatus is installed on the other adjacent side edge of the two adjacent display units. During the process that the two adjacent display units are assembled together, each second driving member 43 is subjected to the second driving force opposite to the direction of the second reset force, and when the second driving force applied to each second driving member 43 is less than the corresponding second reset force, the second signal transmission member 42 is at the second disconnection position, and the two second driving members 43 cannot move or retract into the fourth seat body 41, thereby preventing the second signal transmission member 42 from obliquely penetrating through the fourth seat body 41. When the second driving force applied to each second driving member 43 is greater than the corresponding second reset force, the two second driving members 43 move to drive the second signal transmission member 42 to move towards the first signal transmission member 32, so that the second signal transmission member 42 moves from the second disconnection position to the second conduction position. During this process, each second reset member 44 applies the second reset force to the corresponding second driving member 43, the two second driving members 43 are simultaneously subjected to the second driving forces that enable the second driving members 43 to move, and thus the second driving members 43 simultaneously drive the second signal transmission member 42 to move, the second signal transmission member 42 stably penetrates through the fourth seat body 41, thereby preventing the second signal transmission member 42 from deflecting, so that the second signal transmission member 42 smoothly moves from the second disconnection position to the second conduction position. Moreover, when the two adjacent display units are assembled together, the two adjacent display units are powered on by plugging the power socket 10 and the power plug 20, and the two adjacent display units implement signal transmission by plugging of the signal socket 30 and the signal plug 40, such that the wiring operation is simplified, the assembly of the power line and the signal line is simpler and more convenient, and the assembly efficiency is improved. The two adjacent display units mentioned above may be the first display unit 51 and a fourth display unit 52 in FIG. 4.

It should be noted that, when the second driving force applied to each second driving member 43 is less than the corresponding second reset force, the second signal transmission member 42 is at the second disconnection position, and at this time, the second signal transmission member 42 switches from the second conduction position to the second disconnection position. Or, when each second driving member 43 is not subjected to the second driving force, the second signal transmission member 42 remains at the second disconnection position.

In embodiments not shown in the figures, the number of the second driving members and the number of the second reset members may not be limited to two, and may also be three or more.

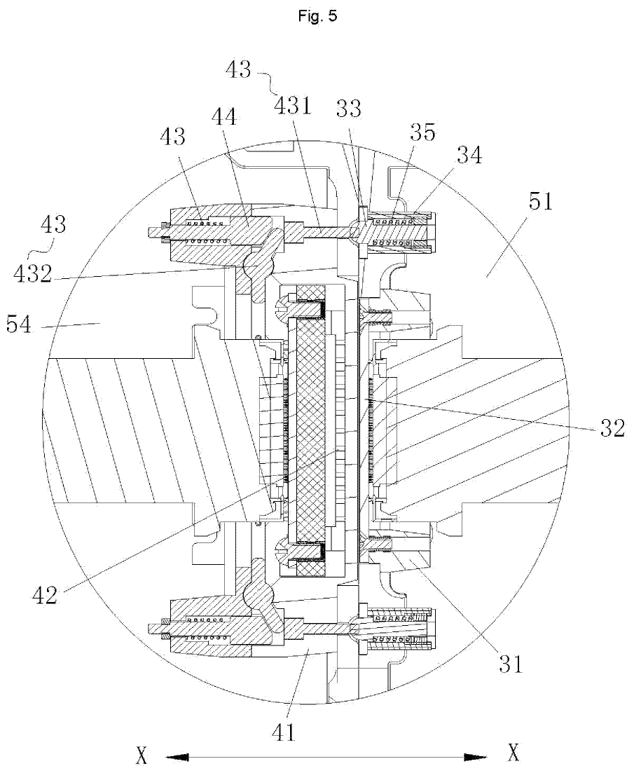

As shown in FIG. 5, FIG. 7, and FIG. 22 to FIG. 29, each second driving member 43 includes a second driving rod 431 movably disposed on the fourth seat body 41 in a penetrating manner, and a second lever plate 432 swingably disposed in the fourth seat body 41, one side of a first end of the second lever plate 432 abuts against the second driving rod 431, a second end of the second lever plate 432 is linked with the second signal transmission member 42, each second reset member 44 abuts against the other side of the first end of the second lever plate 432 of the corresponding second driving member 43, and each second reset member 44 is floatingly disposed in an axial direction of the second driving rod 431 of the corresponding second driving member 43.

In the present embodiment, the driving cooperation between the second driving rod 431 and the second lever plate 432 is similar to the lever principle, so that the second driving member 43 drives the second signal transmission member 42 to move, which is more labor-saving. In order to enable the second signal transmission member 42 to move more smoothly, the other sides of the first ends of the two second lever plates 432 abut against the two second reset members 44 in a one-to-one correspondence manner, and the two second lever plates 432 are respectively located on two sides of the second signal transmission member 42.

As shown in FIG. 5, FIG. 7, and FIG. 22 to FIG. 29, the fourth seat body 41 is provided with an assembly hole, and the second reset member 44 is a second reset rod that is movably disposed in the assembly hole in a penetrating manner. The signal plug 40 further includes a sixth elastic member disposed in the assembly hole. The sixth elastic member applies an elastic force, towards the second driving rod 431, to the second reset rod. Under the action of the elastic force of the sixth elastic member, the first end of the second lever plate 432 is always in an abutting state with an end of the second driving rod 431, and when the second driving force applied to each second driving member 43 is greater than the corresponding second reset force, the second driving rod 431 moves downwards and pushes the first end of the second lever plate 432 to swing, so that the first end of the second lever plate 432 pushes the second reset rod to move in the fourth seat body 41. When the second driving force applied to each second driving member 43 is less than the corresponding second reset force, the first end of the second lever plate 432 is always in the abutting state with the end of the second driving rod 431, the first end of the second lever plate 432 does not swing, and the second signal transmission member 42 is located at the second disconnection position, thereby avoiding a misoperation, or preventing the second signal transmission member 42 from penetrating through the fourth seat body 41 due to the uneven second driving force.

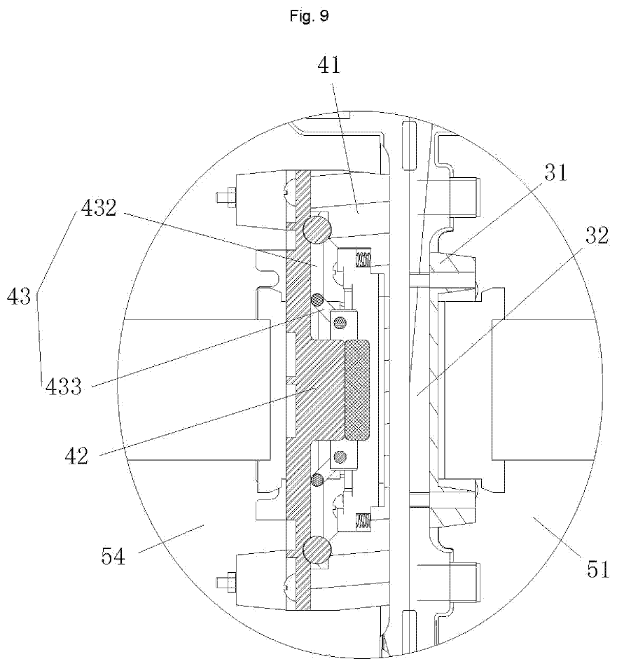

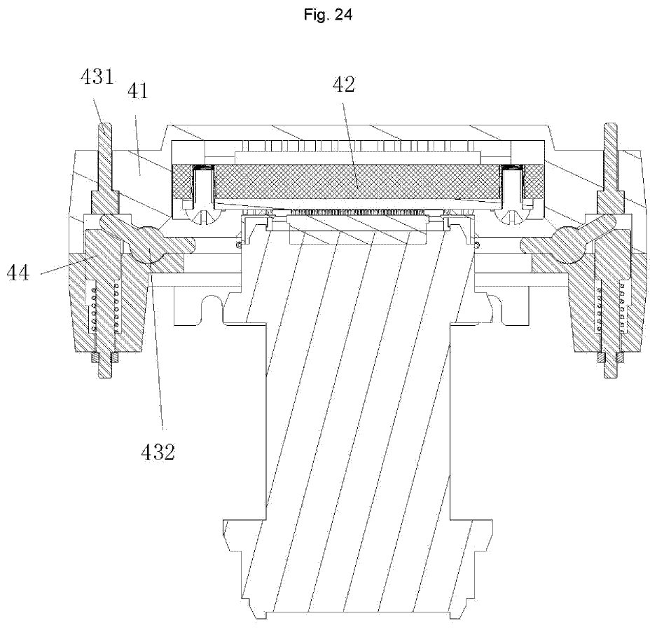

As shown in FIG. 5, FIG. 9, and FIG. 24 to FIG. 27, each second driving member 43 further includes a second connecting rod 433, in each second driving member 43, a first end of the second connecting rod 433 is hinged with the second end of the second lever plate 432, and a second end of the second connecting rod 433 is hinged with the second signal transmission member 42. In this way, the second end of the second lever plate 432 can be linked with the second signal transmission member 42 by the second connecting rod 433. When the second driving force applied to each second driving member 43 is greater than the corresponding second reset force, the second driving member 43 moves leftwards and pushes the first end of the second lever plate 432 to swing around a swing center of the second lever plate 432, and then the second end of the second lever plate 432 swings around the swing center of the second lever plate 432 and pushes the second connecting rod 433 to push the second signal transmission member 42 to move rightwards, such that the second signal transmission member 42 stably moves from the second disconnection position to the second conduction position. In this way, by making the second lever plate 432 linked with the second connecting rod 433, the stability and reliability of each second driving member 43 for driving the second signal transmission member 42 to move are improved.

As shown in FIG. 5, FIG. 9, and FIG. 24 to FIG. 27, the first signal transmission member 32 includes a first signal PCB, and a surface of a side of the first signal PCB facing the second signal transmission member 42 is a gilded surface. The second signal transmission member 42 includes an insulating body movably disposed on the fourth seat body 41, and a signal pin disposed in the insulating body. The signal pin is floatingly disposed relative to the insulating body in the moving direction of the insulating body. The second driving member 43 moves to drive the insulating body to move towards the first signal transmission member 32, so that the signal pin is in contact conduction with the first signal transmission member 32. The second driving member 43 moves to drive the insulating body to move away from the first signal transmission member 32, so that the signal pin is separated from the first signal transmission member 32. The fourth seat body 41 includes a housing and a cover plate covering an opening of the housing, and a part of the second signal transmission member 42 and a part of the second driving member 43 are located in the housing. The signal pin is disposed in the insulating body by a signal spring.

In the present embodiment, the signal plug 40 further includes a flexible circuit plug passing through the fourth seat body 41, the second signal transmission member 42 further includes a second signal PCB, the second signal PCB is disposed on a side of the insulating body facing away from the first signal transmission member 32, the signal pin is electrically connected with the second signal PCB, a PCB socket is disposed on a side of the second signal PCB facing away from the insulating body, the flexible circuit plug is in plug-in contact fit with the PCB socket, and the flexible circuit plug is electrically connected with the signal pin by the second signal PCB. Since the flexible circuit plug can be telescopically deformed, each second driving member 43 drives the insulating body to move in the fourth seat body 41, so that the signal pin moves along with the insulating body.

As shown in FIG. 5, FIG. 9 and FIG. 24, the signal socket 30 further includes a second force application member 33 spaced apart from the third seat body 31, and the second force application member 33 is movably disposed and is capable of pushing the second driving rod 431 to move, so as to drive the second lever plate 432 to swing. The signal socket 30 further includes a second mounting seat 34 spaced apart from the third seat body 31, and a fourth elastic member 35 disposed in the second mounting seat 34, the second force application member 33 is movably located in the second mounting seat 34, the fourth elastic member 35 applies an elastic force, towards the second driving rod 431, to the second force application member 33. In this way, under the action of the elastic force of the fourth elastic member 35, the second force application member 33 floats in the second mounting seat 34 along an X-axis direction of FIG. 5, when during the process that the second signal transmission member 42 moves from the second disconnection position to the second conduction position, the fourth elastic member 35 applies the elastic force, towards the second driving rod 431, to the second force application member 33, so that the second force application member 33 always presses the second driving rod 431, and the second driving rod 431 is clamped between the second lever plate 432 and the second force application member 33, and the second force application member 33 pushes the second driving rod 431, so that the second driving rod 431 quickly pushes the first end of the second lever plate 432 to swing around its swing axis. Moreover, after two adjacent display units are disassembled, the second force application member 33 may retract into the second mounting seat 344 when subjected to collision, thereby preventing the second force application member 33 from penetrating through the second mounting seat 344 to generate interference.

The fourth elastic member 35 is a spring or an elastomer. The second force application member 33 is preferably a second force application rod. The signal socket 30 further includes a third stop ring disposed at the opening of the second mounting seat 34, the side wall of the second force application rod is provided with a fourth stop ring being in stop fit with the third stop ring, and the fourth spherical surface penetrates through the second mounting seat 44 through a center hole of the third stop ring.

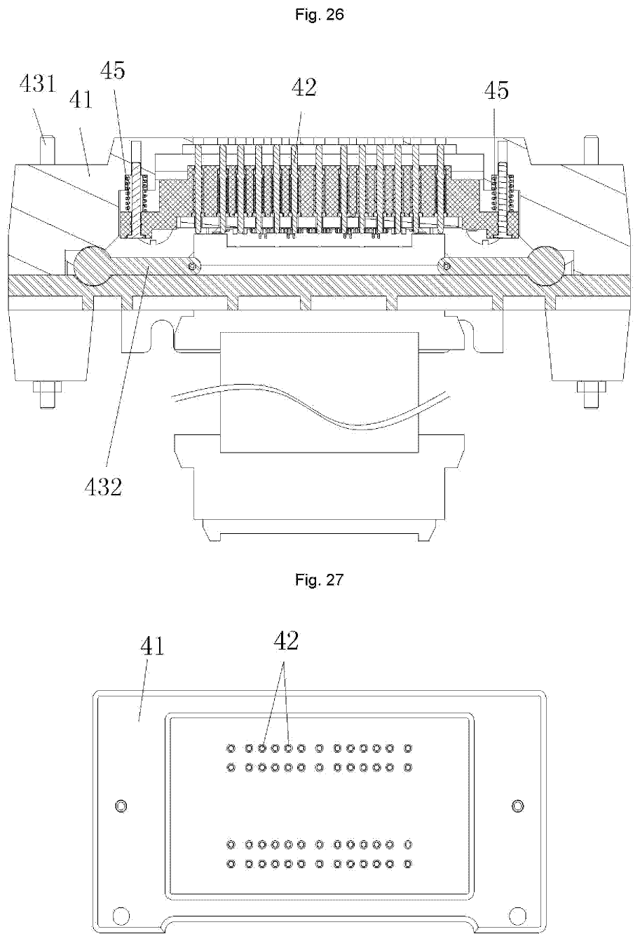

As shown in FIG. 5, FIG. 9, FIG. 24 and FIG. 26, the signal plug 40 further includes a fifth elastic member 45 disposed between the fourth seat body 41 and the second signal transmission member 42, and the fifth elastic member 45 applies an elastic force, in a direction facing away from the third seat body 31, to the second signal transmission member 42. In this way, under the action of the elastic force of the fifth elastic member 45, the second signal transmission member 42 floats in the fourth seat body 41 along the X-axis direction of FIG. 5, and during the process that the second signal transmission member 42 moves from the second conduction position to the second disconnection position, the fifth elastic member 45 applies the elastic force, in the direction facing away from the third seat body 31, to the second signal transmission member 42, so that the second signal transmission member 42 is quickly separated from the first signal transmission member 32. Moreover, after the two adjacent display units are disassembled, the second signal transmission member 42 can be maintained at the second disconnection position, thereby avoiding the second signal transmission member 42 penetrating through the fourth seat body 41 to be damaged or generate interference. The fifth elastic member 45 is a spring or an elastomer, when the fifth elastic member 45 is a spring, the spring is preferably a pressure spring, at this time, the pressure spring in FIG. 26 is installed above the insulating body (see below), of course, in embodiments not shown in the figures, the spring is preferably a tension spring, and at this time, the tension spring is installed below the insulating body.

In the present embodiment, the fourth seat body 41 is provided with a third avoidance hole for avoiding the signal pin, and the fourth seat body 41 is internally provided with a second accommodating hole for mounting the fifth elastic member 45. A guide structure is disposed between the fourth seat body 41 and the insulating body, and the guide structure has the same structure as the guide structure between the second seat body 21 and the insulating substrate.

As shown in FIG. 5, FIG. 9, FIG. 24 and FIG. 26, when the second signal transmission member 42 is at the second conduction position, the second signal transmission member 42 is in point-surface contact fit with the first signal transmission member 32.

It should be noted that, the point-surface contact fit between the second signal transmission member 42 and the first signal transmission member 32 refers to that the end of the signal pin of the second signal transmission member 42 facing the first signal PCB is provided with a third spherical surface, the gilded surface of the first signal PCB faces one end of the signal pin, and the contact manner between the third spherical surface and the gilded surface is point-surface contact. During the process of assembling the two adjacent display units together, the signal pin with the third spherical surface smoothly penetrates through the fourth seat body 41 to form point-surface contact fit with the first signal PCB with the gilded surface, so that the second signal transmission member 42 is at the second conduction position. During the process of disassembling the two adjacent display units, the signal pin with the third spherical surface smoothly retracts into the fourth seat body 41 to be separated from the first signal PCB with the gilded surface, so that the second signal transmission member 42 is at the second disconnection position.

Specifically, the fourth seat body 41 is provided with a third avoidance hole for avoiding the signal pin, during the process that the two adjacent display units are assembled together and the second signal transmission member 42 moves from the second disconnection position to the second conduction position, after a part of the third spherical surface of the signal pin is in slide contact with the hole wall of the third avoidance hole, the moving direction of the signal pin is quickly adjusted, so that the axis of the signal pin is parallel to the axis of the third avoidance hole, and the signal pin can smoothly penetrate through the fourth seat body 41 through the third avoidance hole, so as to form point-surface contact fit with the first signal PCB.

Of course, in embodiments not shown in the figures, the signal socket further includes a second mounting seat spaced apart from the first seat body, and a fourth elastic member disposed in the second mounting seat, the second force application member is movably located in the second mounting seat, the fourth elastic member applies an elastic force, towards the second driving rod, to the second force application member, and the second force application member is able to be in point-surface contact fit with the second driving rod; and the signal plug further includes a fifth elastic member disposed between the fourth seat body and the second signal transmission member, and the fifth elastic member applies an elastic force, in a direction facing away from the third seat body, to the second signal transmission member. Or, when the second signal transmission member is at the second conduction position, the second signal transmission member is in point-surface contact fit with the first signal transmission member.

As shown in FIG. 5, FIG. 9, FIG. 24 and FIG. 26, the second force application member 33 is able to be in point-surface contact fit with the second driving rod 431.

It should be noted that, the point-surface contact fit between the second force application member 33 and the second driving rod 431 refers to that the end of the second force application member 33 facing the second driving rod 431 provided a fourth spherical surface, the end of the second driving rod 431 facing the second force application member 33 is provided with a third plane or a third concave cambered surface, and the contact manner between the fourth spherical surface and the third plane or the third concave cambered surface is point-surface contact. The fourth spherical surface protrudes from the surface of the gilded surface of the first signal PCB facing the fourth seat body 41, the fourth seat body 41 is further provided with a fourth avoidance hole for avoiding the second driving rod 431, the surface of the side edge of the display unit facing the gilded surface of the first signal PCB is provided with a second avoidance concave cambered surface for avoiding the fourth spherical surface, the fourth avoidance hole is located in the second avoidance concave cambered surface, when the second signal transmission member 42 is at the second disconnection position, the end of the second driving rod 431 with the third plane extends into the second avoidance concave cambered surface, and the third plane is lower than or flush with the surface of the side edge of the display unit facing the gilded surface of the first signal PCB.

During the process that the two adjacent display units are assembled together and the second signal transmission member 42 moves from the second disconnection position to the second conduction position, the fourth spherical surface of the second force application member 33 directly forms point-surface contact fit with the third plane of the second driving rod 431, or, the fourth spherical surface of the second force application member 33 moves on the surface of the fourth seat body 41 facing the gilded surface of the first signal PCB, and smoothly slides into the second avoidance concave cambered surface to form point-surface contact fit with the third plane of the second driving rod 431, so that the second driving rod 431 moves leftwards relative to the gilded surface of the first signal PCB and presses the first end of the second lever plate 432, such that the first end of the second lever plate 432 swings around the rotating shaft thereof, and the second end of the second lever plate 432 pushes the second signal transmission member 42 to move rightwards relative to the fourth seat body 41, such that the second signal transmission member 42 is at the second conduction position.

During the process that the two adjacent display units are disassembled and the second signal transmission member 42 moves from the second conduction position to the second disconnection position, a part of the fourth spherical surface of the second force application member 33 slides on the second avoidance concave cambered surface and is gradually separated from the third plane of the second driving rod 431, and the fourth spherical surface of the second force application member 33 may quickly retract into the second mounting seat 34 when subjected to collision, so as to avoid interference with the fourth seat body 41, thereby improving the smoothness of the disassembly process. After the first end of the second lever plate 432 is pushed rightwards, the end of the second driving rod 431 with the third plane extends into the second avoidance concave cambered surface again. Meanwhile, the signal pin with the third spherical surface smoothly retracts into the fourth seat body 41 to be separated from the gilded surface of the first signal PCB, so that the second signal transmission member 42 is at the second disconnection position.

During the process that the two adjacent display units are assembled together, the second signal transmission member 42 floats in the fourth seat body 41 along the X-axis direction of FIG. 5, and the second signal transmission member 42 may smoothly perform the point-surface contact fit with the first signal transmission member 32; and the second force application member 33 floats in the second mounting seat 34 along the X-axis direction of FIG. 5, and the second force application member 33 may smoothly form point-surface contact fit with the second driving rod 431, and there is no interference between the signal socket 30 and the signal pug 40, so that the signal pug 40 can be quickly plugged into the signal socket 30. Similarly, during the process that the two adjacent display units are disassembled, the signal pug 40 may be quickly separated from the signal socket 30. In this way, the signal pug 40 and the signal socket 30 can be automatically connected, so that the signals of the two display units can be automatically transmitted without the need for the field staff to manually plug and unplug the signal pug 40, and thus the field staff can conveniently assemble or disassemble the two display units along the X-axis direction of FIG. 5.

In the present embodiment, the power plug 20, the power socket 10, the signal socket 30 and the signal plug 40 are all assembled by screws at screw hole positions of the corresponding display units.

The present application further provides an LED display apparatus, as shown in FIG. 1 to FIG. 9, the LED display apparatus of the present embodiment includes a first display unit 51, a second display unit 52, a plugging mechanism and two LED display modules, the first display unit 51 and the second display unit 52 are arranged side by side, and the plugging mechanism is the above plugging mechanism of the LED display apparatus. Since the plugging mechanism of the LED display apparatus can solve the problem in the related art that the plug is prone to deflection and thus is difficult to be plugged into the socket, the LED display apparatus with the plugging mechanism can solve the same technical problem.

The power socket 10 of the plugging mechanism is installed on a side edge of the first display unit 51 that is adjacent to the second display unit 52, and the power plug 20 of the plugging mechanism is installed on a side edge of the second display unit 52 that is adjacent to the first display unit 51.

The present application further provides an LED display apparatus, as shown in FIG. 1 to FIG. 9, the LED display apparatus of the present embodiment includes a first display unit 51, a second display unit 52, a third display unit 53, a fourth display unit 54 and a plugging mechanism, the first display unit 51, the second display unit 52, the third display unit 53 and the fourth display unit 54 are arranged in an array and are sequentially distributed in a circumferential direction, and the plugging mechanism is the above plugging mechanism of the LED display apparatus. Since the plugging mechanism of the LED display apparatus can solve the problem in the related art that the plug is prone to deflection and thus is difficult to be plugged into the socket, the LED display apparatus with the plugging mechanism can solve the same technical problem.

The power socket 10 of the plugging mechanism is installed on a side edge of the first display unit 51 that is adjacent to the second display unit 52, and the power plug 20 of the plugging mechanism is installed on a side edge of the second display unit 52 that is adjacent to the first display unit 51. The signal socket 30 of the plugging mechanism is installed on a side edge of the first display unit 51 that is adjacent to the fourth display unit 54, and the signal plug 40 of the plugging mechanism is installed on a side edge of the fourth display unit 54 that is adjacent to the first display unit 51.

As shown in FIG. 1 to FIG. 9, the first display unit 51, the second display unit 52, the third display unit 53 and the fourth display unit 54 are all provided with corresponding through holes for avoiding the power plug 20, the power socket 10, the signal socket 30 and the signal plug 40, so that the power plug 20 and the power socket 10 can be plugged, and the signal socket 30 and the signal plug 40 can be plugged.

In the present embodiment, each of the first display unit 51, the second display unit 52, the third display unit 53 and the fourth display unit 54 includes a box body and a lamp panel module disposed on the front side of the box body, and the plugging mechanism is installed on the back side of the box body. Of course, the plugging mechanism may also be installed on the back side of the lamp panel module.

As shown in FIG. 1 to FIG. 9, in the process of assembling the fourth display unit 54, the third display unit 53, the second display unit 52 and the first display unit 51 in the circumferential direction, the second conductive member 22 may float in the second seat body 21 along the Y-axis direction of FIG. 3, and the second conductive member 22 may smoothly form point-surface contact fit with the first conductive member 12; and the first force application member 13 may float in the first mounting seat 14 along the Y-axis direction of FIG. 3, and the first force application member 13 may smoothly form point-surface contact fit with the first driving rod 231, there is no interference between the power plug 20 and the power socket 10, and the power plug 20 may be quickly plugged into the power socket 10 along the X-axis direction or the Y-axis direction or any ray direction that is led out of the vertex of the angle formed by the X-axis and the Y-axis. Meanwhile, the second signal transmission member 42 may float in the fourth seat body 41 along the X-axis direction of FIG. 5, and the second signal transmission member 42 may smoothly form point-surface contact fit with the first signal transmission member 32; and the second force application member 33 may float in the second mounting seat 34 along the X-axis direction of FIG. 5, and the second force application member 33 may smoothly form point-surface contact fit with the second driving rod 431, there is no interference between the signal socket 30 and the signal plug 40, and the signal plug 40 may be quickly plugged into the signal socket 30 along the X-axis direction or the Y-axis direction or any ray direction that is led out of the vertex of the angle formed by the X-axis and the Y-axis. In this way, the power plug 20 and the power socket 10, and the signal socket 30 and the signal plug 40 are plugged at the same time, and the first display unit 51 may be quickly and accurately assembled to the second display unit 52 and the fourth display unit 54 along the X-axis direction or the Y-axis direction or any ray direction that is led out of the vertex of the angle formed by the X-axis and the Y-axis.

Similarly, in the process of disassembling the fourth display unit 54, the third display unit 53, the second display unit 52 and the first display unit 51 in the circumferential direction, the power plug 20 may be quickly separated from the power socket 10 along the X-axis direction or the Y-axis direction or any ray direction that is led out of the vertex of the angle formed by the X-axis and the Y-axis. The signal plug 40 may be quickly separated from the signal socket 30 along the X-axis direction or the Y-axis direction or any ray direction that is led out of the vertex of the angle formed by the X-axis and the Y-axis. In this way, the power plug 20 and the power socket 10, and the signal socket 30 and the signal plug 40 are unplugged at the same time, so that the first display unit 51 may be quickly and accurately disassembled from the second display unit 52 and the fourth display unit 54 along the X-axis direction or the Y-axis direction or any ray direction that is led out of the vertex of the angle formed by the X-axis and the Y-axis. Accordingly, a wireless (non-flexible wire) connection among the fourth display unit 54, the third display unit 53, the second display unit 52 and the first display unit 51 may be realized, and synchronous plugging and unplugging of the plugging mechanism in the X-axis and Y-axis directions may also be realized.

Of course, in embodiments not shown in the figures, the signal socket of the plugging mechanism is installed on a side edge of the first display unit that is adjacent to the second display unit. The signal plug of the plugging mechanism is installed on a side edge of the second display unit that is adjacent to the first display unit.

It should be noted that, in order to further implement the synchronous plugging and unplugging of the plugging mechanism in the X-axis and Y-axis directions, it is necessary to ensure that the point-surface contact pressure between the second conductive member 22 and the first conductive member 12 is sufficient, and meanwhile, it is necessary to ensure that the point-surface contact pressure of the point-surface contact fit between the first force application member 13 and the first driving rod 231 is sufficient enough, so as to ensure the stable transmission of the power supply and the signal. The force between the power plug 20 and the power socket 10 is designed as follows: the maximum force of pressing the first force application member 13 to the bottom is F1, and the minimum force of the first driving rod 231 is F2; and a force conversion ratio of the first lever plate 232 is N, a theoretical contact pressure between the second conductive member 22 and the first conductive member 12 is F3, a compression reverse thrust of the third elastic member 27 is F4, the compression reverse thrust of the first elastic member 25 is F5, and the gravity of the second conductive member 22 is G1. To ensure stable contact between the second conductive member 22 and the first conductive member 12, the relationship of the above forces is: 2F2N1 (F3+F4+G1)+2F5. The force design between the signal plug 40 and the signal socket 30, and the principle thereof are consistent with the force design between the power plug 20 and the power socket 10, and thus will not be repeated herein.

In the description of the present disclosure, it should be understood that, orientation or position relationships indicated by orientation words such as “front, back, upper, lower, left, right”, “transverse, longitudinal, vertical, horizontal” and “top, bottom” and the like are generally orientation or position relationships shown on the basis of the drawings, and are merely for the convenience of describing the present disclosure and simplifying the description, in the absence of opposite statements, these orientation words do not indicate or imply that the referred apparatuses or elements must have specific orientations or must be constructed and operated in specific orientations, and thus cannot be construed as limitations to the protection scope of the present disclosure; and the orientation words “inside and outside” refer to the inside and outside of the contours of the components themselves.

In addition, it should be noted that, the terms “first”, “second” and the like are used for defining components and parts, and are merely for the convenience of distinguishing the corresponding components and parts, and unless otherwise stated, the above words have no special meaning, and thus cannot be construed as limitations to the protection scope of the present disclosure.

The above descriptions are only preferred embodiments of the present disclosure, and are not intended to limit the present disclosure. For those skilled in the art, the present disclosure may have various modifications and changes. Any modifications, equivalent replacements, improvements and the like, made within the spirit and principles of the present disclosure, shall be included within the protection scope of the present disclosure.

What is claimed is:

1. A plugging mechanism of an LED display apparatus, comprising:
a power socket, comprising a first seat body and a first conductive member disposed on the first seat body; and
a power plug, comprising a second seat body, and a second conductive member movably disposed on the second seat body, a plurality of first driving members and a plurality of first reset members; the plurality of first reset members and the plurality of first driving members are all movably disposed on the second seat body, the plurality of first reset members abut against the plurality of first driving members in a one-to-one correspondence manner, so that each first reset member applies a first reset force to a corresponding first driving member, and the second conductive member has a first conduction position of penetrating through the second seat body and forming contact conduction with the first conductive member, and a first disconnection position of retracting into the second seat body and separating from the first conductive member,
wherein each first driving member is able to be subjected to a first driving force opposite to a direction of the first reset force, and when the first driving force applied to each first driving member is less than a corresponding first reset force, the second conductive member is at the first disconnection position; and when the first driving force applied to each first driving member is greater than the corresponding first reset force, the plurality of first driving members move to drive the second conductive member to move towards the first conductive member, so that the second conductive member moves from the first disconnection position to the first conduction position.

2. The plugging mechanism according to claim 1, wherein,
each first driving member comprises a first driving rod movably disposed on the second seat body in a penetrating manner, and a first lever plate swingably disposed in the second seat body, one side of a first end of the first lever plate abuts against the first driving rod, and a second end of the first lever plate is linked with the second conductive member,
each first reset member abuts against the other side of the first end of the first lever plate of the corresponding first driving member, and each first reset member is floatingly disposed in an axial direction of the first driving rod of the corresponding first driving member.

3. The plugging mechanism according to claim 2, wherein the second seat body is provided with a mounting hole, the first reset member is a first reset rod movably disposed in the mounting hole in a penetrating manner, the power plug further comprises a first elastic member disposed in the mounting hole, the first elastic member applies an elastic force, towards the first driving rod, to the first reset rod, a part of the first reset rod penetrating out of the mounting hole is provided with a stop adjusting member, and the stop adjusting member is in stop fit with a side surface of the second seat body facing away from the first seat body.

4. The plugging mechanism according to claim 3, wherein the first lever plate comprises a first plate segment, a rotating shaft and a second plate segment, which are connected in sequence, an obtuse included angle is formed between the first plate segment and the second plate segment, the rotating shaft is rotatably disposed in the second seat body, the first plate segment abuts against the first driving rod, the second plate segment is linked with the second conductive member, and an end of the first reset rod is provided with an abutting inclined plane that abuts against the first plate segment.

5. The plugging mechanism according to claim 4, wherein the second seat body comprises a seat body base and a bottom plate covering the seat body base, a first arc-shaped recess is disposed on the seat body base, a second arc-shaped recess is disposed on a surface of the bottom plate facing the first arc-shaped recess, and the rotating shaft is clamped between the first arc-shaped recess and the second arc-shaped recess.

6. The plugging mechanism according to claim 2, wherein each first driving member further comprises a first connecting rod, in each first driving member, a first end of the first connecting rod is hinged with the second end of the first lever plate, and a second end of the first connecting rod is hinged with the second conductive member.

7. The plugging mechanism according to claim 2, wherein,
the power socket further comprises a first force application member spaced apart from the first seat body, and the first force application member is movably disposed and is capable of pushing the first driving rod to move, so as to drive the first lever plate to swing; and
the power socket further comprises a first mounting seat spaced apart from the first seat body, and a second elastic member disposed in the first mounting seat, the first force application member is movably located in the first mounting seat, the second elastic member applies an elastic force, towards the first driving rod, to the first force application member, and the first force application member is able to be in point-surface contact fit with the first driving rod.

8. The plugging mechanism according to claim 1, wherein the power plug further comprises a third elastic member disposed between the second seat body and the second conductive member, and the third elastic member applies an elastic force, in a direction facing away from the first seat body, to the second conductive member; and/or, when the second conductive member is at the first conduction position, the second conductive member is in point-surface contact fit with the first conductive member.

9. The plugging mechanism according to claim 1, wherein the power socket further comprises a switch member, and the switch member enables the first conductive member itself to be in an on state or an off state.

10. The plugging mechanism according to claim 9, wherein the first conductive member comprises an input conductor and an output conductor, which are installed in the first seat body, the input conductor and the output conductor are disconnected, the switch member comprises a connecting conductor installed in the first seat body, and an operation key for driving the connecting conductor to move, and when the connecting conductor moves to cooperate with the input conductor and the output conductor, the connecting conductor conducts the input conductor and the output conductor.

11. The plugging mechanism according to claim 1, wherein the plugging mechanism further comprises:
a signal socket, comprising a third seat body, and a first signal transmission member disposed on the third seat body; and
a signal plug, comprising a fourth seat body, a second signal transmission member movably disposed on the fourth seat body, and a plurality of second driving members and a plurality of second reset members; the plurality of second reset members and the plurality of second driving members are all movably disposed on the fourth seat body, the plurality of second reset members abut against the plurality of second driving members in a one-to-one correspondence manner, so that each second reset member applies a second reset force to a corresponding second driving member, the second signal transmission member has a second conduction position of penetrating through the fourth seat body and forming contact conduction with the first signal transmission member, and a second disconnection position of retracting into the fourth seat body and separating from the first signal transmission member,
wherein each second driving member is able to be subjected to a second driving force opposite to a direction of the second reset force, and when the second driving force applied to each second driving member is less than a corresponding second reset force, the second signal transmission member is at the second disconnection position; and when the second driving force applied to each second driving member is greater than the corresponding second reset force, the plurality of second driving members move to drive the second signal transmission member to move towards the first signal transmission member, so that the second signal transmission member moves from the second disconnection position to the second conduction position.

12. The plugging mechanism according to claim 11, wherein,
each second driving member comprises a second driving rod movably disposed on the fourth seat body in a penetrating manner, and a second lever plate swingably disposed in the fourth seat body, one side of a first end of the second lever plate abuts against the second driving rod, and a second end of the second lever plate is linked with the second signal transmission member,
each second reset member abuts against the other side of the first end of the second lever plate of the corresponding second driving member, and each second reset member is floatingly disposed in an axial direction of the second driving rod of the corresponding second driving member;
each second driving member further comprises a second connecting rod, in each second driving member, a first end of the second connecting rod is hinged with the second end of the second lever plate, and a second end of the second connecting rod is hinged with the second signal transmission member;
the signal socket further comprises a second force application member spaced apart from the third seat body, and the second force application member is movably disposed and is capable of pushing the second driving rod to move, so as to drive the second lever plate to swing;
the signal socket further comprises a second mounting seat spaced apart from the third seat body, and a fourth elastic member disposed in the second mounting seat, the second force application member is movably located in the second mounting seat, the fourth elastic member applies an elastic force, towards the second driving rod, to the second force application member, and the second force application member is able to be in point-surface contact fit with the second driving rod; and
the signal plug further comprises a fifth elastic member disposed between the fourth seat body and the second signal transmission member, and the fifth elastic member applies an elastic force, in a direction facing away from the third seat body, to the second signal transmission member; and/or, when the second signal transmission member is at the second conduction position, the second signal transmission member is in point-surface contact fit with the first signal transmission member.

13. An LED display apparatus, comprising a first display unit, a second display unit, a plugging mechanism and a plurality of LED display modules, wherein the first display unit and the second display unit are disposed side by side, the plugging mechanism is the plugging mechanism of the LED display apparatus according to claim 1, the power socket of the plugging mechanism is installed on a side edge of the first display unit that is adjacent to the second display unit, and the power plug of the plugging mechanism is installed on a side edge of the second display unit that is adjacent to the first display unit.

14. An LED display apparatus, comprising a first display unit, a second display unit, a third display unit, a fourth display unit and a plugging mechanism, wherein the first display unit, the second display unit, the third display unit and the fourth display unit are arranged in an array and are sequentially distributed in a circumferential direction, the plugging mechanism is the plugging mechanism of the LED display apparatus according to claim 11,
the power socket of the plugging mechanism is installed on a side edge of the first display unit that is adjacent to the second display unit, and the power plug of the plugging mechanism is installed on a side edge of the second display unit that is adjacent to the first display unit,
wherein the signal socket of the plugging mechanism is installed on the side edge of the first display unit that is adjacent to the second display unit; the signal plug of the plugging mechanism is installed on the side edge of the second display unit that is adjacent to the first display unit; and/or,
the signal socket of the plugging mechanism is installed on a side edge of the first display unit that is adjacent to the fourth display unit, and the signal plug of the plugging mechanism is installed on a side edge of the fourth display unit that is adjacent to the first display unit.
